(19) United States
(12) Patent Application Publication
(10) Pub. No.: US 2015/0336652 A1
(43) Pub. Date: Nov. 26, 2015

(54) MULTILAYERED STRUCTURE AND BALLOON INCLUDING THE SAME

(71) Applicants: Daniel Stuart Smith, Sioux Falls, SD (US); Kun Liang, Sioux Falls, SD (US)

(72) Inventors: Daniel Stuart Smith, Sioux Falls, SD (US); Kun Liang, Sioux Falls, SD (US)

(21) Appl. No.: 14/742,192

(22) Filed: Jun. 17, 2015

Related U.S. Application Data
(63) Continuation-in-part of application No. 13/713,298, filed on Dec. 13, 2012.

(51) Int. Cl. B64B 1/40; B32B 27/32; B32B 27/08

(52) U.S. Cl. CPC B64B 1/40; B32B 27/08; B32B 27/32; B32B 27/325; B32B 2250/42

(57) ABSTRACT

Various embodiments of the present invention relate to a multilayered structure and balloon including the same. In various embodiments, the present invention provides a multilayered structure including at least one A layer (a) including a linear olefin polymer or copolymer, at least one B layer (b) including a cyclic olefin polymer or copolymer, and at least one A layer (c) including a linear olefin polymer or copolymer. The cyclic olefin polymer or copolymer of the at least one B layer is a polymer or copolymer of a substituted or unsubstituted norbornene.

### CROSS-REFERENCE TO RELATED APPLICATIONS

This application is a continuation-in-part of and claims the benefit of priority under 35 U.S.C. §120 to U.S. Utility application Ser. No. 13/713,298, filed Dec. 13, 2012, the disclosure of which is incorporated herein in its entirety by reference.

### BACKGROUND

High-altitude balloons are generally unmanned balloons, usually filled with helium or hydrogen, that are released into the stratosphere, generally attaining an altitude of about 60,000 feet (18 km) to 120,000 feet (37 km). Conditions in the stratosphere can subject the materials in the balloon to severe physical stresses at low temperatures. However, to maximize carrying capacity, lightweight high altitude balloon materials are desirable.

### SUMMARY OF THE INVENTION

In various embodiments, the present invention provides a multilayered structure. The multilayered structure includes at least one A layer (a) including a linear olefin polymer or copolymer. The multilayered structure includes at least one B layer (b) including a cyclic olefin polymer or copolymer. The multilayered structure includes at least one A layer (c) including a linear olefin polymer or copolymer. The cyclic olefin polymer or copolymer of the at least one B layer is a polymer or copolymer of a substituted or unsubstituted norbornene.

In various embodiments, the present invention provides a multilayered structure. The multilayered structure includes an A layer (a) including a linear olefin polymer or copolymer, wherein about 100 wt % of layer (a) is the linear olefin polymer or copolymer, wherein layer (a) is about 4% to about 30% of the total thickness of the multilayered structure. The multilayered structure includes a B layer (b) including a cyclic olefin polymer or copolymer, wherein about 100 wt % of layer (b) is the cyclic olefin polymer or copolymer, wherein layer (b) is about 4% to about 30% of the total thickness of the multilayered structure. The multilayered structure includes an A layer (c) including the linear olefin polymer or copolymer, wherein about 100 wt % of layer (c) is the linear olefin polymer or copolymer, wherein layer (c) is about 4% to about 30% of the total thickness of the multilayered structure. The multilayered structure includes a B layer (d) including the cyclic olefin polymer or copolymer, wherein about 100 wt % of layer (d) is the cyclic olefin polymer or copolymer, wherein layer (d) is about 4% to about 30% of the total thickness of the multilayered structure. The multilayered structure includes an A layer (e) including the linear olefin polymer or copolymer, wherein about 100 wt % of layer (e) is the linear olefin polymer or copolymer, wherein layer (e) is about 4% to about 30% of the total thickness of the multilayered structure. The multilayered structure includes a B layer (f) including the cyclic olefin polymer or copolymer, wherein about 100 wt % of layer (f) is the cyclic olefin polymer or copolymer, wherein layer (f) is about 4% to about 30% of the total thickness of the multilayered structure. The multilayered structure includes an A layer (g) including the linear olefin polymer or copolymer, wherein about 100 wt % of layer (g) is the linear olefin polymer or copolymer, wherein layer (g) is about 4% to about 30% of the total thickness of the multilayered structure. The multilayered structure includes a B layer (h) including the cyclic olefin polymer or copolymer, wherein about 100 wt % of layer (h) is the cyclic olefin polymer or copolymer, wherein layer (h) is about 4% to about 30% of the total thickness of the multilayered structure. The multilayered structure includes an A layer (i) including the linear olefin polymer or copolymer, wherein about 100 wt % of layer (i) is the linear olefin polymer or copolymer, wherein layer (i) is about 4% to about 30% of the total thickness of the multilayered structure. The one or more layers (a) is fully in contact with the one or more layers (b), the one or more layers (b) is fully in contact with the one or more layers (c), the one or more layers (c) is fully in contact with the one or more layers (d), the one or more layers (d) is fully in contact with the one or more layers (e), the one or more layers (e) is fully in contact with the one or more layers (f), the one or more layers (f) is fully in contact with the one or more layers (g), the one or more layers (g) is fully in contact with the one or more layers (h), and the one or more layers (h) is fully in contact with the one or more layers (i). The multilayered structure has an overall thickness of about 0.5 mil to about 1.5 mil. The cyclic olefin polymer or copolymer of the at least one B layer is a polymer or copolymer of a substituted or unsubstituted norbornene.

In various embodiments, the present invention provides a multilayered structure including at least one A layer (a) including a linear olefin polymer or copolymer, wherein about 100 wt % of one or more layers (a) are the linear olefin polymer or copolymer, wherein one or more layers (a) are about 4% to about 30% of the total thickness of the multilayered structure; at least one B layer (b) including a cyclic olefin polymer or copolymer, wherein about 100 wt % of one or more layers (b) is the cyclic olefin polymer or copolymer, wherein one or more layers (b) are about 40% to about 92% of the total thickness of the multilayered structure; and at least one A layer (c) including the linear olefin polymer or copolymer, wherein about 100 wt % of one or more layers (c) is the linear olefin polymer or copolymer, wherein one or more layers (c) are about 4% to about 30% of the total thickness of the multilayered structure. The cyclic olefin polymer or copolymer of the B layer is a polymer or copolymer of a substituted or unsubstituted norbornene. The one or more layers (a) are fully in contact with one or more layers (b) and the one or more layers (b) are fully in contact with one or more layers (c). The multilayered structure has an overall thickness of about 0.5 mil to about 1.5 mil.

In various embodiments, the present invention provides a multilayered structure including an A layer (a) including a linear olefin polymer or copolymer, wherein about 100 wt % of layer (a) is the linear olefin polymer or copolymer, wherein layer (a) is about 4% to about 30% of the total thickness of the multilayered structure; a B layer (b) including a B layer (b1) including a cyclic olefin polymer or copolymer, wherein about 100 wt % of layer (b1) is the cyclic olefin polymer or copolymer, wherein layer (b1) is about 4% to about 30% of the total thickness of the multilayered structure, and a B layer (b2) including the cyclic olefin polymer or copolymer, wherein about 100 wt % of layer (b2) is the cyclic olefin polymer or copolymer, wherein layer (b2) is about 4% to about 30% of the total thickness of the multilayered structure; an A layer (c) including the linear olefin polymer or copolymer, wherein about 100 wt % of layer (c) is the linear olefin polymer or copolymer, wherein layer (c) is about 4% to about 30% of the total thickness of the multilayered structure; a B layer (d) including the cyclic olefin polymer or copolymer, wherein about 100 wt % of layer is the cyclic olefin polymer of copolymer, wherein one or more layer (d) is about 4% to about 30% of the total thickness of the multilayered structure; an A layer (e) including the linear olefin polymer or copolymer, wherein about 100 wt % of layer (e) is the linear olefin polymer or copolymer, wherein layer (e) is about 4% to about 30% of the total thickness of the multilayered structure; a B layer (f) including a B layer (f1) including the cyclic olefin polymer or copolymer, wherein about 100 wt % of layer (f1) is the cyclic olefin polymer or copolymer, wherein layer (f1) is about 4% to about 30% of the total thickness of the multilayered structure, and a B layer (f2) including the cyclic olefin polymer or copolymer, wherein about 100 wt % of layer (f2) is the cyclic olefin polymer or copolymer, wherein layer (f2) is about 4% to about 30% of the total thickness of the multilayered structure; and an A layer (g) including the linear olefin polymer or copolymer, wherein about 100 wt % of layer (g) is the linear olefin polymer or copolymer, wherein layer (g) is about 4% to about 30% of the total thickness of the multilayered structure. The cyclic olefin polymer or copolymer of the B layer is a polymer or copolymer of a substituted or unsubstituted norbornene. The layer (a) is fully in contact with one or more layer (b1), layer (b1) is fully in contact with layer (b2), layer (b2) is fully in contact with layer (c), layer (c) is fully in contact with layer (d), layer (d) is fully in contact with layer (e), layer (e) is fully in contact with layer (f1), and layer (f1) is fully in contact with layer (g). The multilayered structure has an overall thickness of about 0.5 mil to about 1.5 mil.

In various embodiments, the present invention provides a multilayered structure, including an A layer (a) including an A layer (a1) including a linear olefin polymer or copolymer, wherein about 100 wt % layers (a1) is the linear olefin polymer or copolymer, wherein layer (a1) is about 4% to about 30% of the total thickness of the multilayered structure, and an A layer (a2) including the linear olefin polymer or copolymer, wherein about 100 wt % layers (a2) is the linear olefin polymer or copolymer, wherein layer (a2) is about 4% to about 30% of the total thickness of the multilayered structure; a B layer (b) a cyclic olefin polymer or copolymer, wherein about 100 wt % of layer (b) is the cyclic olefin polymer or copolymer, wherein layer (b) is about 4% to about 30% of the total thickness of the multilayered structure, and an A layer (c) including the linear olefin polymer or copolymer, wherein about 100 wt % of layer (c) is the linear olefin polymer or copolymer, wherein layer (c) is about 4% to about 30% of the total thickness of the multilayered structure; a B layer (d) including the cyclic olefin polymer or copolymer, wherein about 100 wt % of layer is the cyclic olefin polymer of copolymer, wherein one or more layer (d) is about 4% to about 30% of the total thickness of the multilayered structure; an A layer (e) including the linear olefin polymer or copolymer, wherein about 100 wt % of layer (e) is the linear olefin polymer or copolymer, wherein layer (e) is about 4% to about 30% of the total thickness of the multilayered structure; a B layer (f) including the cyclic olefin polymer or copolymer, wherein about 100 wt % of layer (f) is the cyclic olefin polymer or copolymer, wherein layer (f1) is about 4% to about 30% of the total thickness of the multilayered structure; and an A layer (g) including an A layer (g1) including the linear olefin polymer or copolymer, wherein about 100 wt % layers (g1) is the linear olefin polymer or copolymer, wherein layer (g1) is about 4% to about 30% of the total thickness of the multilayered structure, and an A layer (g2) including the linear olefin polymer or copolymer, wherein about 100 wt % layers (g2) is the linear olefin polymer or copolymer, wherein layer (g2) is about 4% to about 30% of the total thickness of the multilayered structure. The cyclic olefin polymer or copolymer of the B layer is a polymer or copolymer of a substituted or unsubstituted norbornene. The layer (a1) is fully in contact with layer (a2), layer (a2) is fully in contact with layer (b), layer (b) is fully in contact with layer (c), layer (c) is fully in contact with layer (d), layer (d) is fully in contact with layer (e), layer (e) is fully in contact with layer (f), layer (f) is fully in contact with layer (g1), and layer (g1) is fully in contact with layer (g2). The multilayered structure has an overall thickness of about 0.5 mil to about 1.5 mil.

In various embodiments, the present invention provides a method of making a multilayered structure. The method includes extruding a multilayered structure. The multilayered structure includes at least one A layer (a) including a linear olefin polymer or copolymer. The multilayered structure includes at least one B layer (b) including at least one ocyclic olefin polymer or cyclic olefin copolymer. The multilayered structure includes at least one A layer (c) including a linear olefin polymer or copolymer. The cyclic olefin polymer or copolymer of the at least one B layer is a polymer or copolymer of a substituted or unsubstituted norbornene.

In various embodiments, the multilayered structure of the present invention has certain advantages over other multilayered structures, at least some of which are unexpected. In various embodiments, the present invention provides a multilayered structure having a higher strength than other films, such as a higher strength (e.g., greater tensile strength) at lower temperatures than other films. In various embodiments, the present invention provides a multilayered structure having a higher strength to weight ratio than other films. In various embodiments, the present invention provides a multilayered structure having greater dimensional stability than other films, such as higher dimensional stability at different temperatures (e.g., low temperatures) than other films. In various embodiments, the present invention provides a multilayered structure having a longer lifetime than other films. In various embodiments, the present invention provides a multilayered structure having better properties at low temperatures, such as better strength and less brittleness, than other films. In various embodiments, the present invention provides a multilayered structure having better heat sealability than other films. In various embodiments, the present invention provides a multilayered structure that is more easily recycled than other films. In various embodiments, the present invention provides a multilayered structure having greater optical clarity than other films. In various embodiments, the present invention provides a multilayered structure having better electrostatic properties than other films (e.g., less prone to static build-up). In various embodiments, the present invention provides a multilayered structure that is easier to store than other films.

In various embodiments, the multilayered structure of the present invention can have superior physical and mechanical properties as compared to other multilayered materials including the same. In various embodiments, the multilayered structures of the present invention can be less expensive to manufacture than other films. Tie layers can be weak aspects of other multilayered structures, as seam failures often start as delamination between a strength layer (such as nylon) and a polyethylene layer, especially at cold temperatures. In various embodiments, the multilayered structures of the present invention can be free of expensive tie layers, providing a multilayered structure having improved performance over tie layer-containing multilayered structures, such as nylon-polyethylene structures.

### BRIEF DESCRIPTION OF THE FIGURES

The drawings illustrate generally, by way of example, but not by way of limitation, various embodiments discussed in the present document.

FIG. 1 illustrates a multilayered structure, in accordance with various embodiments

FIG. 2 illustrates a multilayered structure, in accordance with various embodiments

FIG. 3A-C illustrate a multilayered structure, in accordance with various embodiments

FIG. 4 illustrates a multilayered structure, in accordance with various embodiments

FIG. 5 illustrates a multilayered structure, in accordance with various embodiments

FIG. 6 illustrates a multilayered structure, in accordance with various embodiments

FIG. 7 illustrates a multilayered structure, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. For example, an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “heterocyclyl” as used herein refers to aromatic and non-aromatic ring compounds containing three or more ring members, of which one or more is a heteroatom such as, but not limited to, N, O, and S.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group, respectively, that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

The term “standard temperature and pressure” as used herein refers to 20° C. and 101 kPa.

The term “mil” as used herein refers to a thousandth of an inch, such that 1 mil=0.001 inch.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Multilayered Structure.

In various embodiments, the present invention provides a multilayered structure. The multilayered structure can include at least one A layer (a) including a linear olefin polymer or copolymer, at least one B layer (b) including a cyclic olefin polymer or copolymer, and at least one A layer (c) including a linear olefin polymer or copolymer. The multilayered structure is a multilayered film that can be suitable for use as a balloon skin, such as for high-altitude ballons.

Each layer can be partially or fully in contact with the one or more adjacent layers. For one layer to contact the other layer, the surface of one layer can be fused to the other, such that the planar distributions of material in each layer are adjacent to the another. In some examples, contacting can include at least some mixing of the materials in one layer with the other layer. In some examples, contacting can include a different material at the interface between layers due to a chemical reaction at the time of fusing or later, due to the application of adhesive between the layers, or a combination thereof. Two contacting layers having substantially all of the major side of at least one layer contacting at least part of the major side of another layer can be fully contacting one another. In another example, two layers can be fully contacting one another when substantially all of one major side of one layer is contacting substantially all of one major side of the other layer. Two layers can be partially contacting one another when a major side from one layer contacts the a major side of another layer, but less than all of a major side of one layer is contacting less than all of a major side of the other layer. When a group of similar layers (e.g., at least one B layer (b) including layers (b1) and (b2)) is referred to at being at least partially in contact with another layer, each member of the group need not be in partial contact with the other layer; however, at least one member of the group contacts the other layer (e.g., at least partially, or fully).

Each A layer can include one more linear olefin polymers or copolymers. Each B layer can include one or more cyclic olefin polymers or copolymers. The multilayered structure can include A layers (e.g., linear olefin polymer or copolymer-containing layers that include at least one linear olefin polymer or copolymer) alternating with B layers (e.g., cyclic olefin polymer or copolymer-containing layers that include at least one cyclic olefin polymer or copolymer). For example, the multilayered structure can have the structure A-B-A, A-A-B-A, AA-BB-A, or AA-BB-AA, wherein each example structure includes A layers alternating with B layers. In some examples, each A layer alternates with each B layer, such as A-B-A, A-B-A-B, A-B-A-B-A, and the like.

The multilayered structure can include A layers on one or more major external surface thereof (e.g., wherein the multilayered structure has two major external surfaces: the top surface and the bottom surface). The multilayered structure can include an A layer on one major external surface. The multilayered structure can include an A layer on each major external surface. Each B layer can include either a B layer or an A layer on each major surface thereof. Each major surface of each A layer in the multilayered structure can have either a B layer thereon, an A layer thereon, or is an external surface on the multilayered structure.

In various embodiments, the multilayered structure includes is free of layers other than A layers and B layers. The total thickness of the multilayered structure can be substantially the same as the total thickness of all of the A layers in the multilayered structure and all of the B layers in the multilayered structure. Each A layer can be at least partially in contact with (e.g., partially or fully in contact with) one or more B layers. Each B layer can be at least partially in contact with (e.g., partially or fully in contact with) one or more A layers.

In some embodiments, one or more layers further from an external surface of the multilayered structure can include a lower percentage of linear olefin polymer or copolymer than one or more layers that are closer to a major external surface of the multilayered structure. In some embodiments, one or more layers further from an external surface of the multilayered structure can include a higher percentage of cyclic olefin polymer or copolymer than one or more layers that are closer to a major external surface of the multilayered structure.

In various embodiments, the multilayered structure can be free of adhesive between one or more layers. In various embodiments, the multilayered structure can be free of tie layers between one or more layers.

The multilayered structure can have any suitable total linear olefin polymer or copolymer content, such as about 1 wt % to about 99 wt %, about 30 wt % to about 99 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, or about 99 wt % or more of the multilayered structure. The multilayered structure can have any suitable cyclic olefin polymer or copolymer content, such as about 1 wt % to about 99 wt %, about 30 wt % to about 99 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, or about 99 wt % or more of the multilayered structure.

The multilayered structure, or all of the A and B layers of the multilayered structure combined can have any suitable total thickness, such as about 0.1 mil to about 10 mils, about 0.5 mil to about 1.5 mils, or about 0.1 mil or less, or about 0.2 mil, 0.3, 0.4, 0.5, 0.6, 0.7, 0.8, 0.9, 1, 1.1, 1.2, 1.3, 1.4, 1.5, 1.6, 1.8, 2, 2.5, 3, 3.5, 4, 4.5, 5, 6, 7, 8, 9, or about 10 mils or more.

The multilayered structure can have any suitable tensile strength at yield, as consistent with the multilayered structure described herein. For example, at about room temperature, in the machine direction, the multilayered structure can have a tensile strength at yield of about 5 MPa to about 100 MPa per 1 mil total thickness, or about 20 MPa to about 30 MPa, or about 5 MPa or less, or about 10 MPa, 15, 16, 17, 18, 19, 20, 21, 22, 23, 24, 25, 26, 27, 28, 29, 30, 31, 32, 33, 34, 35, 40, 45, 50, 55, 60, 65, 70, 75, 80, 85, 90, 95, or about 100 MPa or more. At about −40° C., in the machine direction, the multilayered structure can have a tensile strength at yield of about 5 MPa to about 100 MPa per 1 mil total thickness, about 40 MPa to about 50 MPa, or about 5 MPa or less, or about 10 MPa, 15, 20, 25, 30, 35, 36, 37, 38, 39, 40, 41, 42, 43, 44, 45, 46, 47, 48, 49, 50, 51, 52, 53, 54, 55, 60, 65, 70, 75, 80, 85, 90, 95, or about 100 MPa or more. At about −60° C., in the machine direction, the multilayered structure can have a tensile strength at yield of about 5 MPa to about 100 MPa per 1 mil total thickness, about 60 MPa to about 75 MPa, or about 5 MPa or less, or about 10 MPa, 15, 20, 25, 30, 35, 40, 45, 50, 55, 56, 57, 58, 59, 60, 61, 62, 63, 64, 65, 66, 67, 68, 69, 70, 71, 72, 73, 74, 75, 80, 85, 90, 95, or about 100 MPa or more. The multilayered structure can have substantially similar tensile strength at yield at various temperatures in the direction transverse to the machine direction.

The multilayered structure can have any suitable elongation at yield, as consistent with the multilayered structure described herein. For example, at about room temperature, in the machine direction, the multilayered structure can have an elongation at yield of about 2% to about 10%, about 6% to about 7%, or about 2% or less, or about 3%, 4, 4.5, 5, 5.2, 5.4, 5.6, 5.8, 6, 6.2, 6.3, 6.4, 6.5, 6.6, 6.7, 6.8, 6.9, 7.0, 7.2, 7.4, 7.6, 7.8, 8, 8.5, 9, or about 10% or more. At about −40° C., in the machine direction, the multilayered structure can have an elongation at yield of about 2% to about 10%, about 5.5% to about 7%, or about 2% or less, or about 3%, 4.5, 4.6, 4.8, 5, 5.2, 5.4, 5.5, 5.6, 5.7, 5.8, 5.9, 6, 6.1, 6.2, 6.3, 6.4, 6.5, 6.6, 6.7, 6.8, 6.9, 7, 7.2, 7.4, 7.6, 7.8, 8, 8.5, 9, or about 10% or more. At about −60° C., in the machine direction, the multilayered structure can have an elongation at yield of about 2% to about 10%, about 5.5% to about 7.5%, or about 2% or less, or about 3%, 4.5, 4.6, 4.8, 5, 5.2, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.8, 8, 8.2, 8.4, 8.5, 9, 9.5, or about 10% or more.

The multilayered structure can be substantially recyclable. For example, the multilayered structure can be more easily recyclable than multilayered structures including nylon. The cyclic olefin polymer or copolymer can be easily recycled along with the polyethylene.

The multilayered structure can be at least partially transparent; for example, either translucent or transparent. The multilayered structure can be substantially or fully transparent, or the multilayered structure can be only slightly transparent. The multilayered structure can have about 0% to about 100% of the optical light transmittance of a fully transparent material (e.g., as measured by ASTM D-1003), about 50% to about 100%, or about 0%, 10%, 20%, 30%, 40%, 50%, 60%, 70%, 80%, 90%, 95%, 96%, 96%, 97%, 98%, 99%, 99.5%, 99.9%, 99.99%, 99.999%, 99.9999%, or 99.99999% of the optical light transmittance of a fully transparent material. The multilayered structure can have substantially the same light transmissibility throughout, or it can have some locations that allow through different amounts of light than others.

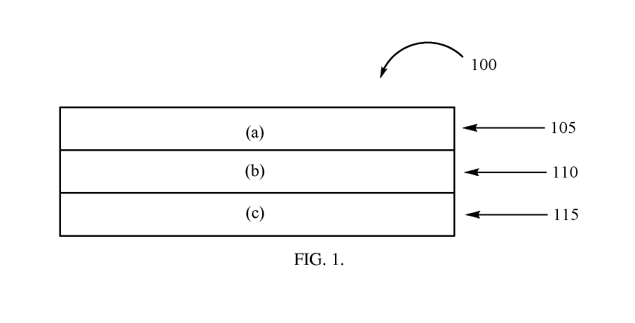

Referring to FIG. 1, in some embodiments, the 3-layered multilayered structure 100 includes at least one A layer (a) 105 including a linear olefin polymer or copolymer, at least one B layer (b) 110 including a cyclic olefin polymer or copolymer, and at least one A layer (c) 115 including a linear olefin polymer or copolymer. The one or more layers (a) 105 and the one or more layers (c) 115 are external layers of the multilayered structure 100. The one or more layers (a) 105 are fully in contact with the one or more layers (b) 110, and the one or more layers (b) 110 are fully in contact with the one or more layers (c) 115.

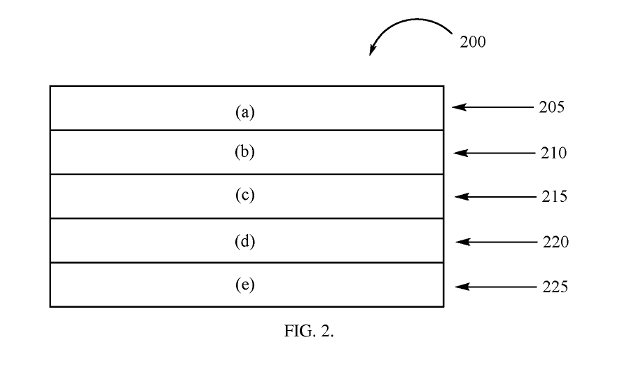

Referring to FIG. 2, in some embodiments, the 5-layered multilayered structure 200 includes at least one A layer (a) 205 including a linear olefin polymer or copolymer; at least one B layer (b) 210 including a cyclic olefin polymer or copolymer; at least one A layer (c) 215 including a linear olefin polymer or copolymer; at least one B layer (d) 220 including a cyclic olefin polymer or copolymer; and at least one A layer (e) 225 including a linear olefin polymer or copolymer. The one or more layers (a) 205 and the one or more layers (e) 225 are external layers of the multilayered structure. The one or more layers (a) 205 are fully in contact with the one or more layers (b) 210. The one or more layers (b) 210 are fully in contact with the one or more layers (c) 215. The one or more layers (c) 215 are fully in contact with the one or more layers (d) 220. The one or more layers (d) 220 are fully in contact with the one or more layers (e) 225.

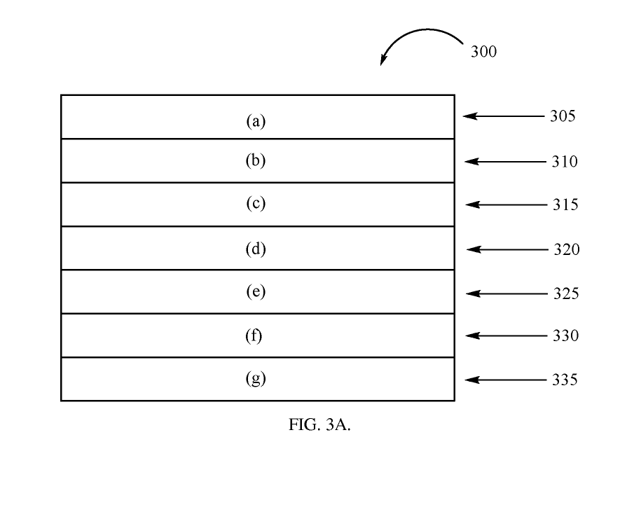

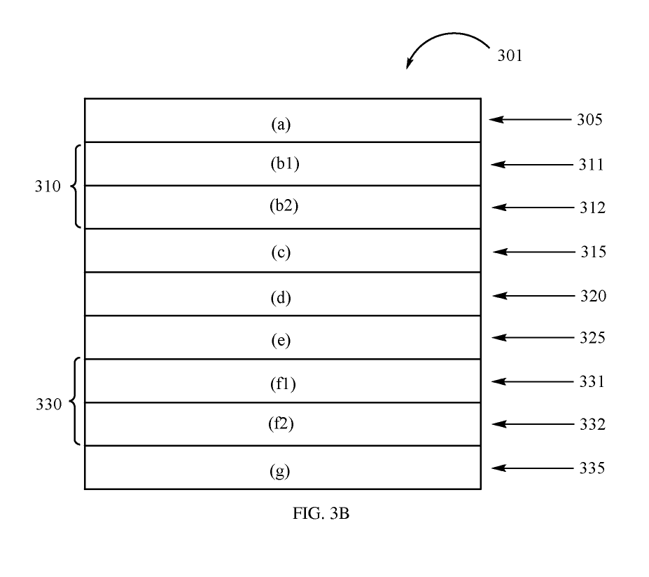

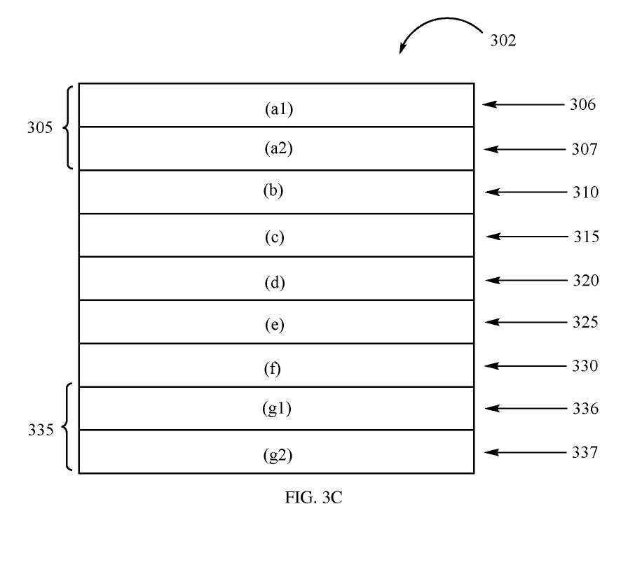

Referring to FIG. 3A, in some embodiments, the 7-layered multilayered structure 300 includes at least one A layer (a) 305 including a linear olefin polymer or copolymer; at least one B layer (b) 310 including a cyclic olefin polymer or copolymer; at least one A layer (c) 315 including a linear olefin polymer or copolymer; at least one B layer (d) 320 including a cyclic olefin polymer or copolymer; at least one A layer (e) 325 including a linear olefin polymer or copolymer; at least one B layer (f) 330 including a cyclic olefin polymer or copolymer; and at least one A layer (g) 335 including a linear olefin polymer or copolymer. The one or more layers (a) 305 and the one or more layers (g) 335 are external layers of the multilayered structure. The one or more layers (a) 305 are fully in contact with the one or more layers (b) 310. The one or more layers (b) 310 are fully in contact with the one or more layers (c) 315. The one or more layers (c) 315 are fully in contact with the one or more layers (d) 320. The one or more layers (d) 320 are fully in contact with the one or more layers (e) 325. The one or more layers (e) 325 are fully in contact with the one or more layers (f) 330. The one or more layers (f) 330 are fully in contact with the one or more layers (g) 335.

In some embodiments, the multilayered structure 300 shown in FIG. 3A can include more than one A layer or more than one B layer in place of layer (a), (b), (c), (d), (e), (f), or (g). Referring to FIG. 3B, an 8-layered multilayered structure 301 includes at least one A layer (a) 305 including a linear olefin polymer or copolymer; at least one B layer (b) 310 including a B layer (b1) 311 including a cyclic olefin polymer or copolymer, and a B layer (b2) 312 including a cyclic olefin polymer or copolymer; at least one A layer (c) 315 including a linear olefin polymer or copolymer; at least one B layer (d) 320 including a cyclic olefin polymer or copolymer; at least one A layer (e) 325 including a linear olefin polymer or copolymer; at least one B layer (f) 330 including a B layer (f1) 331 including a cyclic olefin polymer or copolymer, and a B layer (f2) 332 including a cyclic olefin polymer or copolymer; and at least one A layer (g) 335 including a linear olefin polymer or copolymer. The one or more layers (a) 305 are fully in contact with the layer (b1) 311. The layer (b1) 311 is fully in contact with the layer (b2) 312. The layer (b2) 312 is fully in contact with the one or more layers (c) 315. The one or more layers (e) 325 are fully in contact with the layer (f1) 331. The layer (f1) 331 is fully in contact with the layer (f2) 332. The layer (f2) 332 is fully in contact with the one or more layers (g) 325. One or more B layers 310, including layers (b1) 311 and (b2) 312 are fully in contact with layer (a) 305 and layer (c) 315. When a group of similar layers (e.g., a group of A layers or a group of B layers) is referred to as being at least partially or fully in contact with another layer, each member of the group need not be in partial contact with the other layer; however, at least one member of the group contacts the other layer (e.g., at least partially, or fully). Referring to FIG. 3C, the multilayered structure 302 can include at least one A layer (a) 305 including an A layer (a1) 306 including a linear olefin polymer or copolymer, and an A layer (a2) 307 including a linear olefin polymer or copolymer; at least one B layer (b) 310 including a cyclic olefin polymer or copolymer; at least one A layer (c) 315 including a linear olefin polymer or copolymer; at least one B layer (d) 320 including a cyclic olefin polymer or copolymer; at least one A layer (e) 325 including a linear olefin polymer or copolymer; at least one B layer (f) 330 including a cyclic olefin polymer or copolymer; and at least one A layer (g) 335 including an A layer (g1) 336 including a linear olefin polymer or copolymer, and an A layer (g2) 337 including a linear olefin polymer or copolymer. The layer (a1) 306 is fully in contact with the layer (a2) 307. The layer (a2) 307 is fully in contact with the one or more layers (b) 310. The one or more layers (f) 330 are fully in contact with the layer (g1) 336. The layer (g1) 336 is fully in contact with the layer (g2) 337.

In some embodiments, the multilayered structure can be an 8-layered structure. For example, the multilayered structure can include at least one A layer (a) including a linear olefin polymer or copolymer; at least one B layer (b) including a cyclic olefin polymer or copolymer; at least one A layer (c) including a linear olefin polymer or copolymer; at least one B layer (d) including a cyclic olefin polymer or copolymer; at least one A layer (e) including a linear olefin polymer or copolymer; at least one B layer (f) including a cyclic olefin polymer or copolymer; at least one A layer (g) including a linear olefin polymer or copolymer; and at least one B layer (h) including a cyclic olefin polymer or copolymer. The one or more layers (a) and the one or more layers (h) are external layers of the multilayered structure. The one or more layers (a) are at least partially in contact with the one or more layers (b). The one or more layers (b) are at least partially in contact with the one or more layers (c). The one or more layers (c) are at least partially in contact with the one or more layers (d). The one or more layers (d) are at least partially in contact with the one or more layers (e). The one or more layers (e) are at least partially in contact with the one or more layers (f). The one or more layers (f) are at least partially in contact with the one or more layers (g). The one or more layers (g) are at least partially in contact with the one or more layers (h). In some embodiments, the 8-layered structure described can have more than one layer A or more than one layer B in any of layers (a), (b), (c), (d), (e), (f), (g), or (h). For example, the multilayered structure can include at least one A layer (a) including a linear olefin polymer or copolymer; at least one B layer (b) including a cyclic olefin polymer or copolymer; at least one A layer (c) including a linear olefin polymer or copolymer; at least one B layer (d) including a B layer (d1) including a cyclic olefin polymer or copolymer, and a B layer (d2) including a cyclic olefin polymer or copolymer; at least one A layer (e) including a linear olefin polymer or copolymer; at least one B layer (f) including a cyclic olefin polymer or copolymer; at least one A layer (g) including a linear olefin polymer or copolymer; and at least one B layer (h) including a cyclic olefin polymer or copolymer. The one or more layers (c) are at least partially in contact with the layer (d1). The layer (d1) is at least partially in contact with the layer (d2). The one or more layers (d2) are at least partially in contact with the one or more layers (e). In some embodiments, the multilayered structure of can include at least one A layer (a) including a linear olefin polymer or copolymer; at least one B layer (b) including a cyclic olefin polymer or copolymer; at least one A layer (c) including a linear olefin polymer or copolymer; at least one B layer (d) including a cyclic olefin polymer or copolymer; at least one A layer (e) including an A layer (e1) including a linear olefin polymer or copolymer, and an A layer (e2) including a linear olefin polymer or copolymer; at least one B layer (f) including a cyclic olefin polymer or copolymer; at least one A layer (g) including a linear olefin polymer or copolymer; and at least one B layer (h) including a cyclic olefin polymer or copolymer. The one or more layers (d) are at least partially in contact with the layer (e1). The layer (e1) is at least partially in contact with the layer (e2). The layer (e2) is at least partially in contact with the one or more layers (f).

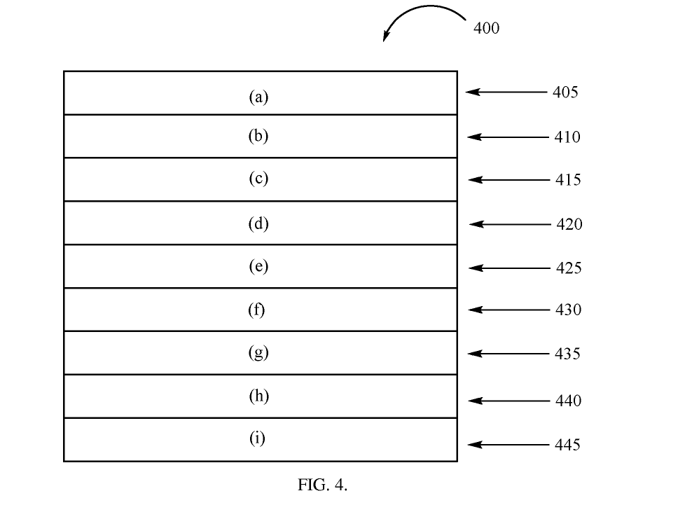

Referring to FIG. 4, in some embodiments, the 9-layered multilayered structure 400 includes at least one A layer (a) 405 including a linear olefin polymer or copolymer; at least one B layer (b) 410 including a cyclic olefin polymer or copolymer; at least one A layer (c) 415 including a linear olefin polymer or copolymer; at least one B layer (d) 420 including a cyclic olefin polymer or copolymer; at least one A layer (e) 425 including a linear olefin polymer or copolymer; at least one B layer (f) 430 including a cyclic olefin polymer or copolymer; at least one A layer (g) 435 including a linear olefin polymer or copolymer; at least one B layer (h) 440 including a cyclic olefin polymer or copolymer; and at least one A layer (i) 445 including a linear olefin polymer or copolymer. The one or more layers (a) 405 and the one or more layers (i) 445 are external layers of the multilayered structure. The one or more layers (a) 405 are fully in contact with the one or more layers (b) 410. The one or more layers (b) 410 are fully in contact with the one or more layers (c) 415. The one or more layers (c) 415 are fully in contact with the one or more layers (d) 420. The one or more layers (d) 420 are fully in contact with the one or more layers (e) 425. The one or more layers (e) 425 are fully in contact with the one or more layers (f) 430. The one or more layers (f) 430 are fully in contact with the one or more layers (g) 435. The one or more layers (g) 435 are fully in contact with the one or more layers (h) 440. The one or more layers (h) 440 are fully in contact with the one or more layers (i) 445.

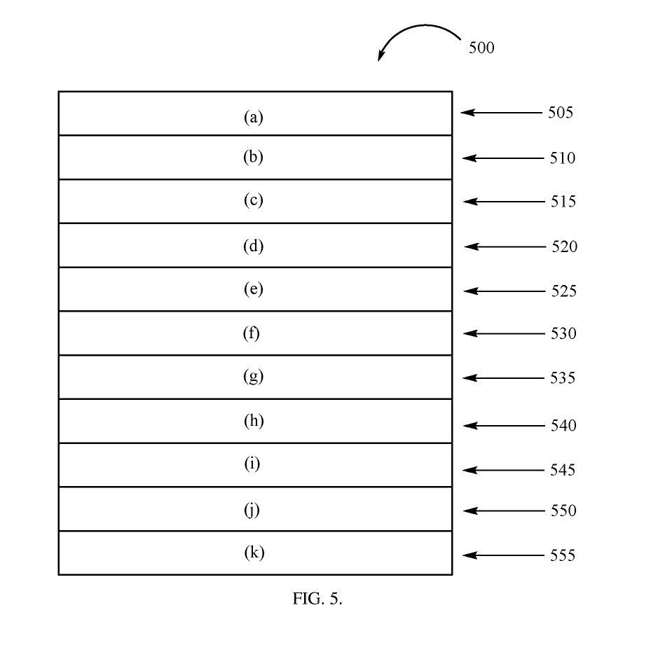

Referring to FIG. 5, in some embodiments, the 11-layered multilayered structure 500 can have at least one A layer (a) 505 including a linear olefin polymer or copolymer; at least one B layer (b) 510 including a cyclic olefin polymer or copolymer; at least one A layer (c) 515 including a linear olefin polymer or copolymer; at least one B layer (d) 520 including a cyclic olefin polymer or copolymer; at least one A layer (e) 525 including a linear olefin polymer or copolymer; at least one B layer (f) 530 including a cyclic olefin polymer or copolymer; at least one A layer (g) 535 including a linear olefin polymer or copolymer; at least one B layer (h) 540 including a cyclic olefin polymer or copolymer; at least one A layer (i) 545 including a linear olefin polymer or copolymer; at least one B layer (j) 550 including a cyclic olefin polymer or copolymer; and at least one A layer (k) 555 including a linear olefin polymer or copolymer. The one or more layers (a) 505 and the one or more layers (k) 555 are external layers of the multilayered structure. The one or more layers (a) 505 are fully in contact with the one or more layers (b) 510. The one or more layers (b) 510 are fully in contact with the one or more layers (c) 515. The one or more layers (c) 515 are fully in contact with the one or more layers (d) 520. The one or more layers (d) 520 are fully in contact with the one or more layers (e) 525. The one or more layers (e) 525 are fully in contact with the one or more layers (f) 530. The one or more layers (f) 530 are fully in contact with the one or more layers (g) 535. The one or more layers (g) 535 are fully in contact with the one or more layers (h) 540. The one or more layers (h) 540 are fully in contact with the one or more layers (i) 545. The one or more layers (i) 545 are fully in contact with the one or more layers (j) 550. The one or more layers (j) 550 are fully in contact with the one or more layers (k) 555.

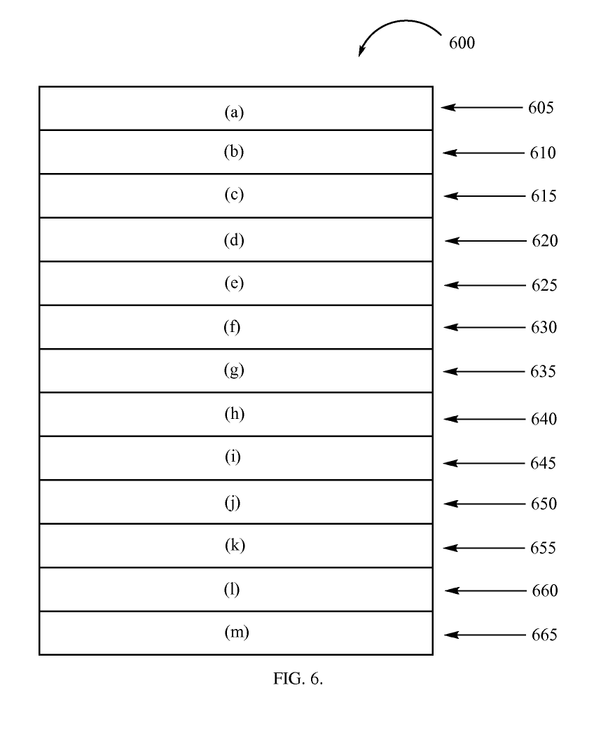

Referring to FIG. 6, in some embodiments, the 13-layered multilayered structure 600 can have at least one A layer (a) 605 including a linear olefin polymer or copolymer; at least one B layer (b) 610 including a cyclic olefin polymer or copolymer; at least one A layer (c) 615 including a linear olefin polymer or copolymer; at least one B layer (d) 620 including a cyclic olefin polymer or copolymer; at least one A layer (e) 625 including a linear olefin polymer or copolymer; at least one B layer (f) 630 including a cyclic olefin polymer or copolymer; at least one A layer (g) 635 including a linear olefin polymer or copolymer; at least one B layer (h) 640 including a cyclic olefin polymer or copolymer; at least one A layer (i) 645 including a linear olefin polymer or copolymer; at least one B layer (j) 650 including a cyclic olefin polymer or copolymer; at least one A layer (k) 655 including a linear olefin polymer or copolymer; at least one B layer (l) 660 including a cyclic olefin polymer or copolymer; and at least one A layer (m) 665 including a linear olefin polymer or copolymer. The one or more layers (a) 605 and the one or more layers (m) 665 are external layers of the multilayered structure. The one or more layers (a) 605 are fully in contact with the one or more layers (b) 610. The one or more layers (b) 610 are fully in contact with the one or more layers (c) 615. The one or more layers (c) 615 are fully in contact with the one or more layers (d) 620. The one or more layers (d) 620 are fully in contact with the one or more layers (e) 625. The one or more layers (e) 625 are fully in contact with the one or more layers (f) 630. The one or more layers (f) 630 are fully in contact with the one or more layers (g) 635. The one or more layers (g) 635 are fully in contact with the one or more layers (h) 640. The one or more layers (h) 640 are fully in contact with the one or more layers (i) 645. The one or more layers (i) 645 are fully in contact with the one or more layers (j) 650. The one or more layers (j) 650 are fully in contact with the one or more layers (k) 655. The one or more layers (k) 655 are fully in contact with the one or more layers (l) 660. The one or more layers (l) 660 are fully in contact with the one or more layers (m) 665.

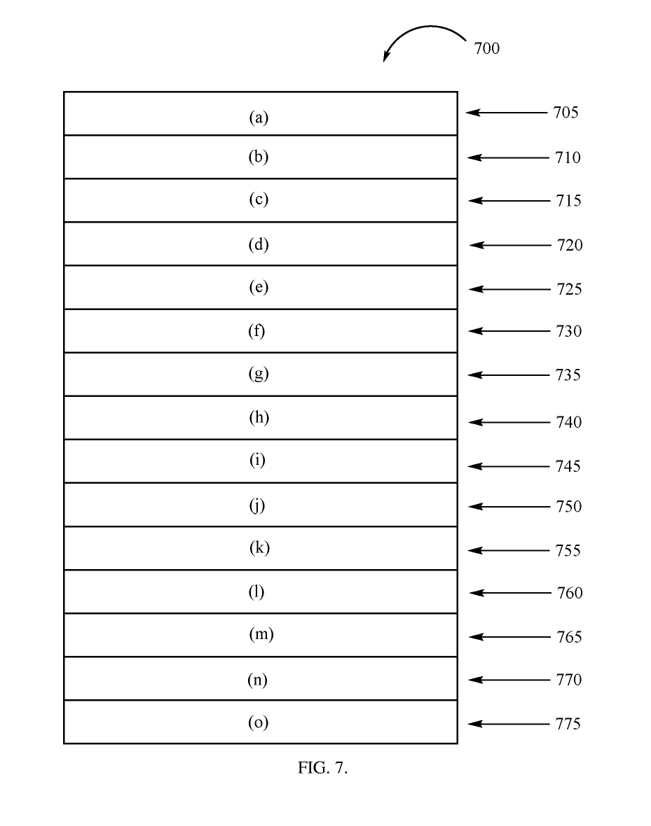

Referring to FIG. 7, in some embodiments, the 15-layered multilayered structure 700 can have at least one A layer (a) 705 including a linear olefin polymer or copolymer; at least one B layer (b) 710 including a cyclic olefin polymer or copolymer; at least one A layer (c) 715 including a linear olefin polymer or copolymer; at least one B layer (d) 720 including a cyclic olefin polymer or copolymer; at least one A layer (e) 725 including a linear olefin polymer or copolymer; at least one B layer (f) 730 including a cyclic olefin polymer or copolymer; at least one A layer (g) 735 including a linear olefin polymer or copolymer; at least one B layer (h) 740 including a cyclic olefin polymer or copolymer; at least one A layer (i) 745 including a linear olefin polymer or copolymer; at least one B layer (j) 750 including a cyclic olefin polymer or copolymer; at least one A layer (k) 755 including a linear olefin polymer or copolymer; at least one B layer (l) 760 including a cyclic olefin polymer or copolymer; at least one A layer (m) 765 including a linear olefin polymer or copolymer; at least one B layer (n) 770 including a cyclic olefin polymer or copolymer; and at least one A layer (o) 775 including a linear olefin polymer or copolymer. The one or more layers (a) 705 and the one or more layers (o) 775 are external layers of the multilayered structure. The one or more layers (a) 705 are fully in contact with the one or more layers (b). The one or more layers (b) 710 are fully in contact with the one or more layers (c). The one or more layers (c) 715 are fully in contact with the one or more layers (d). The one or more layers (d) 720 are fully in contact with the one or more layers (e). The one or more layers (e) 725 are fully in contact with the one or more layers (f). The one or more layers (f) 730 are fully in contact with the one or more layers (g). The one or more layers (g) 735 are fully in contact with the one or more layers (h). The one or more layers (h) 740 are fully in contact with the one or more layers (i). The one or more layers (i) 745 are fully in contact with the one or more layers (j). The one or more layers (j) 750 are fully in contact with the one or more layers (k). The one or more layers (k) 755 are fully in contact with the one or more layers (l). The one or more layers (l) 760 are fully in contact with the one or more layers (m). The one or more layers (m) 765 are fully in contact with the one or more layers (n). The one or more layers (n) are fully in contact with the one or more layers (o).

The multilayered structure can be used to form any suitable product. The multilayered structure can be formed into one or more bags or other shapes. For example, the structure can be cut to a desired size, or the structure can be sealed at a suitable location to fuse one section of the structure to another. For example, the multilayered structure can be used for any suitable purpose. For example, the multilayered structure can be used for packaging such as food packaging, plastic bags, labels, building construction, landscaping, electrical fabrication, photographic film, packaging such as food packaging or packaging for other commodities. In one example, the multilayered structure can be used to form one or more gas-carrying compartments of a balloon.

### At Least One A Layer.

The multilayered structure includes at least one A layer. As used herein, A layers are layers including a linear olefin polymer or copolymer. The multilayered structure can include any suitable number of A layers, such as 1, 2, 3, 4, 5, 6, 7, 8, 9, 10, 11, 12, 13, 14, 15, 16, 17, 18, 19, 20 or more. In the multilayered structure, all of the A layers combined (e.g., all of the linear olefin polymer or copolymer-containing layers combined) can form any suitable proportion of the total weight of the multilayered structure, such as about 1 wt % to about 99 wt %, about 30 wt % to about 99 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, or about 99 wt % or more of the multilayered structure. The thickness of each A layer at each occurrence can be independently about 0.01 mil to about 1 mil, about 0.1 mil to about 0.5 mil, or about 0.01 mil or less, or about 0.05, 0.1, 0.15, 0.2, 0.25, 0.3, 0.35, 0.4, 0.45, 0.5, 0.6, 0.7, 0.8, 0.9, or about 1 mil or more. The thickness of each A layer at each occurrence can be independently about 1% to about 99% of the total thickness of the multilayered structure, or about 4% to about 30%, about 40% to about 92%, about 2% to about 90%, about 3% to about 50%, or about 1% or less, or about 2%, 3, 4, 5, 6, 7, 8, 9, 10, 12, 14, 16, 18, 20, 25, 30, 35, 40, 45, 50, 55, 60, 65, 70, 75, 80, 85, 90, 91, 92, 93, 94, 95, 96, 97, 98%, or about 99% or more.

At each occurrence, each A layer can independently include one linear olefin polymer or copolymer, or more than one linear olefin polymer or copolymer. The one or more linear olefin polymers or copolymers can form any suitable proportion of each A layer. At each occurrence, about 1 wt % to about 100 wt % of each A layer can independently be the one or more linear olefin polymers or copolymers, about 40 wt % to about 100 wt %, about 5 wt % to about 100 wt %, about 60 wt % to about 100 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, 99, 99.9, 99.99 wt %, or about 100 wt %.

The one or more linear olefin polymers or copolymers can be any suitable one or more linear olefin polymers or copolymers. For example, the linear olefin polymer or copolymer of each A layer can be at each occurrence independently chosen from ultra high molecular weight polyethylene (UHMWPE), high-density polyethylene (HDPE), cross-linked polyethylene (PEX or XLPE), medium density polyethylene (MDPE), linear low-density polyethylene (LLDPE), low-density polyethylene (LDPE), very low-density polyethylene (VLDPE), a copolymer thereof, or a combination thereof. The linear olefin polymer or copolymer of each A layer can be at each occurrence independently chosen from a polymer or copolymer of at least one of propene, butene, pentene, heptene, hexene, octene, nonene, decene, ethylene, a (C₁-C₁₀)alkylenoic acid, a vinyl (C₁-C₁₀)alkanoate ester, and a (C₁-C₁₀)alkyl (C₁-C₁₀)alkylenoate ester. The linear olefin polymer or copolymer of each A layer can be at each occurrence independently chosen from a linear low-density polyethylene (LLDPE) that includes a copolymer of ethylene and octene, or a combination thereof.

In addition to the linear olefin polymer or copolymer, each A layer at each occurrence can independently further include an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof. In addition to the linear olefin polymer or copolymer, each A layer at each occurrence independently further includes a linear low density polyethylene (LLLDPE), a metallocene-catalyzed PE, an ethylene-vinyl acetate (EVA) polymer, an ethylene-n-butyl acetate polymer (EnBA), or a combination thereof. Any one of more materials in this paragraph can independently form any suitable proportion of each A layer, such as 0%, such as about 0.001 wt % to about 99 wt %, or about 0.001 wt % to about 50 wt %, or about 0.001 wt % or less, or equal to or less than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, or about 99 wt %.

### At Least One B Layer.

The multilayered structure includes at least one B layer. As used herein, B layers are layers including at least one cyclic olefin polymer or copolymer (e.g., including, for example, combinations thereof). The multilayered structure can include any suitable number of B layers, such as 1, 2, 3, 4, 5, 6, 7, 8, 9, 10, 11, 12, 13, 14, 15, 16, 17, 18, 19, 20 or more. In the multilayered structure, all of the B layers combined (e.g., all of the linear olefin polymer or copolymer-containing layers combined) can form any suitable proportion of the total weight of the multilayered structure, such as about 1 wt % to about 99 wt %, about 30 wt % to about 99 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, or about 99 wt % or more of the multilayered structure. The thickness of each B layer at each occurrence can be independently about 0.01 mil to about 1 mil, about 0.1 mil to about 0.5 mil, or about 0.01 mil or less, or about 0.05, 0.1, 0.15, 0.2, 0.25, 0.3, 0.35, 0.4, 0.45, 0.5, 0.6, 0.7, 0.8, 0.9, or about 1 mil or more. The thickness of each B layer at each occurrence can be independently about 1% to about 99% of the total thickness of the multilayered structure, or about 4% to about 30%, about 40% to about 92%, about 2% to about 90%, about 3% to about 50%, or about 1% or less, or about 2%, 3, 4, 5, 6, 7, 8, 9, 10, 12, 14, 16, 18, 20, 25, 30, 35, 40, 45, 50, 55, 60, 65, 70, 75, 80, 85, 90, 91, 92, 93, 94, 95, 96, 97, 98%, or about 99% or more.

At each occurrence, each B layer can independently include one cyclic olefin polymer or copolymer, or more than one cyclic olefin polymer or copolymer. The one or more cyclic olefin polymer or copolymer can form any suitable proportion of each B layer. At each occurrence, about 1 wt % to about 100 wt % of each B layer can independently be the one or more cyclic olefin polymer or copolymers, about 40 wt % to about 100 wt %, about 50 wt % to about 100 wt %, about 60 wt % to about 100 wt %, or about 1 wt % or less, or about 2, 3, 4, 5, 6, 8, 10, 12, 14, 16, 18, 20, 25, 30, 35, 40, 45, 50, 55, 60, 65, 70, 75, 80, 85, 86, 88, 90, 92, 94, 95, 96, 97, 98, 99, 99.9, 99.99 wt %, or about 100 wt %.

The cyclic olefin polymer or copolymer of the at least one B layer can be a polymer or copolymer of a substituted or unsubstituted norbornene, a cyclic olefin having the substituted or unsubstituted structure:

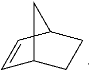

The cyclic olefin polymer or copolymer of each B layer can be at each occurrence independently a polymer or copolymer of at least one cyclic olefin selected from 8,9,10-trinorborn-2-ene (“norbornene”), 8,9,10-trinorborn-2-ene substituted at at least one of the 5- and 6-position independently with R³, 1,2,3,4,4a,5,8,8a-octahydro-1,4:5,8-dimethanonaphthalene (“tetracyclododecene”), and 1,2,3,4,4a,5,8,8a-octahydro-1,4:5,8-dimethanonaphthalene substituted at at least one of the 2- or 3-position with R³, wherein R³ at each occurrence is independently selected from methyl, ethyl, propyl, butyl, and pentyl, wherein R³ is branched or unbranched.

The cyclic olefin polymer or copolymer of each B layer at each occurrence can independently have the structure:

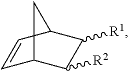

The variables R¹ and R² at each occurrence can be each independently selected from H, (C₁-C₁₀)alkyl, (C₂-C₁₀)alkenyl, (C₂-C₁₀)alkynyl, (C₁-C₁₀)haloalkyl, (C₁-C₁₀)alkoxy, (C₁-C₁₀)haloalkoxy, (C₁-C₁₀)cycloalkyl(C₀-C₁₀)alkyl, (C₁-C₁₀)heterocyclyl(C₀-C₁₀)alkyl, (C₁-C₁₀)aryl(C₀-C₁₀)alkyl, and (C₁-C₁₀)heteroaryl(C₀-C₁₀)alkyl, F, Cl, Br, I, OR, CN, CF₃, OCF₃, R, O, S, C(O), S(O), methylenedioxy, ethylenedioxy, N(R)₂, SR, S(O)R, SO₂R, SO₂N(R)₂, SO₃R, C(O)R, C(O)C(O)R, C(O)CH₂C(O)R, C(S)R, C(O)OR, OC(O)R, OC(O)OR, C(O)N(R)₂, OC(O)N(R)₂, C(S)N(R)₂, (CH₂)₀₋₂NHC(O)R, N(R)N(R)C(O)R, N(R)N(R)C(O)OR, N(R)N(R)C(O)N(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(C(O)R)C(O)R, N(OR)R, C(═NH)N(R)₂, C(O)N(OR)R, and C(═NOR)R, or wherein R¹ and R² together form the substituted or unsubstituted structure:

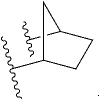 [SMILES: *C1CCC(*)C1]

The variable R at each occurrence can be independently substituted or unsubstituted and is selected from the group consisting of hydrogen, (C₁-C₁₀)alkyl, (C₁-C₁₀)cycloalkyl, (C₁-C₁₀)cycloalkyl(C₁-C₁₀)alkyl, (C₁-C₁₀)aryl, (C₁-C₁₀)aralkyl, (C₁-C₁₀)heterocyclyl, (C₁-C₁₀)heterocyclyl(C₁-C₁₀)alkyl, (C₁-C₁₀)heteroaryl, and (C₁-C₁₀)heteroaryl(C₁-C₁₀)alkyl. The cyclic olefin polymer or copolymer of each B layer at each occurrence can independently have the structure:

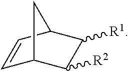

The variables R¹ and R² at each occurrence can be each independently selected from H, (C₁-C₁₀)alkyl, (C₁-C₁₀)haloalkyl, (C₁-C₁₀)alkoxy, (C₁-C₁₀)haloalkoxy, F, Cl, Br, I, CN, CF₃, OCF₃, or wherein R¹ and R² together form the structure:

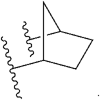 [SMILES: *C1CCC(*)C1]

The cyclic olefin polymer or copolymer of each B layer at each occurrence can be independently a copolymer of a cyclic olefin and at least one of ethylene, propene, butene, pentene, heptene, hexene, octene, nonene, decene, a (C₁-C₁₀)alkylenoic acid, a vinyl (C₁-C₁₀)alkanoate ester, and a (C₁-C₁₀)alkyl (C₁-C₁₀)alkylenoate ester. The cyclic olefin polymer or copolymer of each B layer at each occurrence independently can be a copolymer of ethylene and at least one cyclic olefin selected from 8,9,10-trinorborn-2-ene (norbornene), 1,2,3,4,4a,5,8,8a-octahydro-1,4:5,8-dimethanonaphthalene (tetracyclododecene).

In addition to the at least one cyclic olefin polymer or copolymer, each B layer at each occurrence can independently further include an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof. In addition to the cyclic olefin polymer or copolymer, each B layer at each occurrence can independently further include a linear low density polyethylene (LLLDPE), a metallocene-catalyzed PE, an ethylene-vinyl acetate (EVA) polymer, an ethylene-n-butyl acetate polymer (EnBA), or a combination thereof. Any one of more materials in this paragraph can independently form any suitable proportion of each B layer, such as 0 wt %, such as about 0.001 wt % to about 99 wt %, or about 0.001 wt % to about 50 wt %, or about 0.001 wt % or less, or equal to or less than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, or about 99 wt %.

### Other Layers.

In addition to the one or more A layers and the one or more B layers, the multilayered structure can include any one or more additional layers in any suitable location in the multilayered structure. For example the multilayered structure can include one or more additional layers each independently including an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof. The multilayered structure can further include one or more additional layers including a linear low density polyethylene (LLLDPE), a metallocene-catalyzed PE, an ethylene-vinyl acetate (EVA) polymer, an ethylene-n-butyl acetate polymer (EnBA), or a combination thereof. Any one of more materials in this paragraph can independently form any suitable proportion of each additional layer at each occurrence, such as 0 wt %, such as about 0.001 wt % to about 99 wt %, or about 0.001 wt % to about 50 wt %, or about 0.001 wt % or less, or equal to or less than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, or about 99 wt %.

### Optional Ingredients.

At each occurrence, each layer (e.g., A layer, B layer, additional layer) can independently include any one or more optional ingredients. Optional ingredients can be added during any suitable stage of making the multilayered structure; for example, the optional ingredient can be added to a resin, or can be added to the structure after extrusion. Optional ingredients can include a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, an antioxidant, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, an antioxidant, a pigment, a polyolefin, a flow control additive, scrim, antistatic additives, antiblock additives, or a combination thereof. In some embodiments, Any one of more materials in this paragraph can independently form any suitable proportion of each additional layer at each occurrence, such as 0 wt %, such as about 0.001 wt % to about 99 wt %, or about 0.001 wt % to about 50 wt %, or about 0.001 wt % or less, or equal to or less than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, or about 99 wt %.

### Balloon.

In various embodiments, the present invention provides a balloon including at least one embodiment of the multilayered structure described herein, wherein the multilayered structure includes the gas-enclosing portion of the balloon (e.g., the skin). The balloon can be any suitable balloon. The balloon can be a high-altitude balloon that can be filled with a suitable gas such as helium or hydrogen and can be released into the stratosphere, generally attaining an altitude of about 60,000 feet (18 km) to 120,000 feet (37 km). The balloon can be a pumpkin balloon or a lobed balloon. Lobed balloons can be constructed with a lightweight material that is provided in diamond shaped panels of material (a gore pattern) that extend from top end to a bottom end and taper from near a midpoint toward the top and bottom ends. The diamond shaped panels can be bonded to one another along their respective longitudinal edges to form the balloon. The balloon accordingly can have a plurality of longitudinal seams extending from the top to the bottom of the balloon (one seam for each of the diamond shaped panels). The wider midpoint of each of the diamond shaped panels provides the outwardly curving shape of the balloon with respect to the narrower top and bottom ends. Optionally, a balloon can be constructed with an upper and a lower panel coupled together along an edge. In other examples a nested inner balloon (e.g., a ballonet) is provided within a larger balloon (e.g., a balloon within a balloon). The ballonet is coupled at an end of the larger balloon, for instance the bottom end of the larger balloon, and has a roughly spherical shape that fills at least a portion of the larger balloon. The ballonet (inner balloon) is inflated within the larger balloon. Inflation and deflation of the ballonet with atmospheric air provides ballast to the larger balloon by minimizing the remaining volume of the larger balloon dedicated to a lighter than air gas that provides buoyancy. The balloon, the ballonet, or both, can include the multilayered structure. The balloon can optionally include a payload, such as instruments, communications equipment, and the like, coupled with or suspended from the balloon.

In various embodiments, the present invention provides a method of using an embodiment of the balloon. In various embodiments, the present invention provides a method of making a balloon, including making a balloon that includes the multilayered structure.

The following documents are hereby incorporated by reference, as if appearing herein in their entirety: U.S. application Ser. No. 13/827,779, published as U.S. Patent Publication No. 2014/0158823; U.S. Application No. 62/088,040; and U.S. Application No. 62/128,309.

### Method of Making the Multilayered Structure.

In various embodiments, the present invention provides a method of making a multilayered structure. The method can be any suitable method that forms an embodiment of the multilayered structure described herein. For example, the method can include extruding an embodiment of the multilayered structure described herein, such as a multilayered structure including at least one A layer (a) including a linear olefin polymer or copolymer; at least one B layer (b) including a cyclic olefin polymer or copolymer; and at least one A layer (c) including a linear olefin polymer or copolymer.

The method can include extruding (e.g. coextruding) one or more resins. The extrusion can be conducted with any suitable equipment. The extrusion can be, for example, at least one of cast sheet extrusion, cast film extrusion, blown sheet extrusion, and blown film extrusion. In some examples, the method can include extruding a plurality of resins, wherein each layer is extruded from at least one of the resins. The resin can include any suitable material, including any optional ingredients described herein. The method can include extruding a resin including a linear olefin polymer or copolymer. The method can also include extruding a resin including at least one cyclic olefin copolymer or cyclic olefin polymer. The extruded resins form any multilayered structure described herein. For example, the extruded resins form a multilayered structure including at least one first layer including a linear olefin polymer or copolymer, and including at least one second layer including at least one cyclic olefin copolymer or cyclic olefin polymer. In some examples, the multilayered structure can be formed using coextrusion of any suitable combination of resins, followed by any suitable treatment such as coating, heat treatment, radiation treatment, or any combination thereof.

### EXAMPLES

Various embodiments of the present invention can be better understood by reference to the following Examples which are offered by way of illustration. The present invention is not limited to the Examples given herein.

The TOPAS® 8007-F600 was a copolymer of ethylene and norbornene (CAS 26007-43-2), provided by TOPAS®, having (as measured on a 2.76 mil cast specimen): a density, using ISO 1183, of 1020 kg/m³; a melt volume rate (MVR) (230° C., 2.16 kg), using ISO 1133, of 12 cm³/10 min; melt volume rate (MVR) (190° C., 2.16 kg), using ISO 1133, of 2 cm³/10 min; a melt flow rate (MFR) (230° C., 2.16 kg) of 11 g/10 min; a melt flow rate (MFR) (190° C., 2.16 kg) of 1.8 g/10 min; a water absorption (23° C.-sat), using ISO 62, of 0.01%; a glass transition temperature (10° C./min), using ISO 11357-1,-2,-3, of 172° F.; a tensile modulus, using ISO 527-3, machine direction (MD) 300 kpsi, transverse to machine direction (TD) 250 kpsi; a tensile strength @ break, using ISO 527-3, machine direction 8000 psi, transverse direction 7300 psi; an elongation at break, using ISO 527-3, MD 3.4%, TD 3.4%; and a water vapor permeability @ 38° C., 90% RH, using ISO 15106-3, of 0.22 g×mil/100 in²×day.

The DOWLEX™ 2056 G was a linear low density polyethylene, an ethene-1-octene copolymer (CAS 26221-73-8) having (as measured on a 1 mil (25 μm) blown film made using a screw size of 3.5 in, a screw type of DSB II, a die gap of 70 mil (1.8 mm), a melt temperature of 419° F., an output of 12 lb/hr/in of die circumference, a die diameter of 8 in, a blow-up ratio of 2.5:1, a screw speed of 39 rpm, and a frost line height of 39 in): a density, using ASTM D792, of 0.920 g/cm³; a melt index (190° C./2.16 kg), using ASTM D1238, of 1.0 g/10 min; a film puncture energy of 14.0 in·lb (1.58 J); a film puncture force of 14.0 lbf (62.3 N); a film puncture resistance of 305 ft·lb/in3 (25.2 J/cm³); a film toughness, using ASTM D882, in the machine direction (MD) of 1390 ft·lb/in³ (115 J/cm³), and in the direction transverse to the machine direction (TD) of 1550 ft·lb/in³ (128 J/cm³); a secant modulus, using ASTM D882, 1% Secant MD 25300 psi (174 MPa), 2% Secant MD 23200 psi (160 MPa), 1% Secant TD 26000 psi (179 MPa), 2% Secant TD 23900 psi (165 MPa); a tensile strength, using ASTM D882, MD yield 1700 psi (11.7 MPa), TD Yield 1740 psi (12.0 MPa), MD break 7200 psi (49.6 MPa), TD Break 6000 psi (41.4 MPa); a tensile elongation, using ASTM 0882, MD break 700%, TD break 550%; a dart drop impact, using ASTM D1709A, of 220 g; an Elmendorf tear strength, using ASTM D1922, of MD 400 g, TD 600 g; a Vicat softening temperature, using ASTM D1525, of 216 F (102 C), a melting temperature (DSC) of 246 F (119 C), a gloss (45°), using ASTM D2457, of 26; and a haze, using ASTM D1003, of 23%.

The 62 metallocene was MarFlex® D163, linear low density polyethylene, a copolymer of hexene and ethylene produced using a metallocene catalyst, provided by Chevron Phillips Chemical Company LLC. The 82 octene was DOWLEX™ 2045 G polyethylene resin, linear low density polyethylene, a copolymer of octene and ethylene produced using a Ziegler-Natta catalyst, provided by the Dow Chemical Company. The 28 tie was DuPont™ Bynel® 4157, an anhydride-modified, linear low-density polyethylene resin provided by DuPont™. The Nylon was UBE Nylon 5033B, provided by UBE Engineering Plastics S.A.

The MarFlex® D350 was a linear low density polyethylene, a copolymer of hexane and ethylene producing using a metallocene catalyst, provided by Chevron Philips Chemical Company, having (as measured on a blown film made using a 2.5:1 blow up ratio, a die gap of 80 mil, 8 inch die, 250 lbs/hr, with a melt temperature of 400° F.): a density, using ASTM D1505, of 0.933 g/cm³; a melt index, using ASTM D1238, or 0.9 g/10 min; a haze, using ASTM D1003, of 5%, a 60° gloss, using ASTM D2457, of 123; a COF, using ASTM D1894, of 0.7; a dart, using ASTM D1709, or 80 g/mil, a Elmendorf tear, using ASTM D1922, MD/TD, of 35/300 g/mil; a tensile strength at yield, using ASTM D882, MD/TD, of 18/22 MPa; a tensile strength at break, using ASTM D882, MD/TD, of 53/46 MPa; an elongation at break, using ASTM D882, MD/TD, of 432/585 MPa; a film puncture energy, using ASTM D3763, of 1.5 J; a film puncture force, using ASTM D3763, of 32 N; a seal initiation temperature (temperature at which 0.3 lb/in heat seal strength is achieved, using a Theller heat sealer, 1.0 s dwell, 60 psi pressure, 11.8 in/min separation), using ASTM F88, of 115° C.

The TOPAS® 8007-F400 was a copolymer of ethylene and norbornene, having: a volume flow index MVR at 260° C., 2.16 kg, using ISO 1133, of 32 ml/10 min; a volume flow index MVR at HDT+115° C., 2.16 kg, using ISO 1133, of 2 ml/10 min; a density, using ISO 1183, of 1.02 g/cm³; a water absorption (24 h immersion in water at 23° C.), using ISO 62, of <0.01%; water vapor permeability (at 23° C. and 85% relative humidity), using DIN 53 122, of 0.023 g·mm/m²·d; a mold shrinkage (60° C., 2 mm wall thickness) of 0.4-0.7; tensile strength [5 mm/min], using ISO 527 parts 1 and 2, of 63 MPa; elongation at break [5 mm/min], using ISO 527 parts 1 and 2, of 10% (with a yield strain of 4.5%); tensile modulus [1 mm/min], using ISO 527 parts 1 and 2, of 2600 MPa; a Charpy impact strength, using ISO 179/1eU, of 20 kJ/m²; a notched Charpy impact strength, using ISO 179/1eA, of 2.6 kJ/m²; and a ball indentation hardness, 30-second value, using ISO 2039 part 1, with an applied load of 961 N, of 130 N/mm²; a heat deflection temperature HDT/B (0.45 MPa), using ISO 75 parts 1 and 2, of 75° C.; a coefficient of linear thermal expansion, using ISO 11 359 parts 1 and 2, of 0.7×10⁻⁴ K⁻¹; and a light transmission (2 mm wall thickness), using ISO 13468-2, of 91%.

The TOPAS® 6013F-04 was a copolymer of ethylene and norbornene, having: a volume flow index MVR at 260° C., 2.16 kg, using ISO 1133, of 14 ml/10 min; a volume flow index MVR at HDT+115° C., 2.16 kg, using ISO 1133, of 6 ml/10 min; a density, using ISO 1183, of 1.02 g/cm³; a water absorption (24 h immersion in water at 23° C.), using ISO 62, of <0.01%; water vapor permeability (at 23 C and 85% relative humidity), using DIN 53 122, of 0.035 g·mm/m²·d; a mold shrinkage (60° C., 2 mm wall thickness) of 0.4-0.7; tensile strength [5 mm/min], using ISO 527 parts 1 and 2, of 63 MPa; elongation at break [5 mm/min], using ISO 527 parts 1 and 2, of 2.7%; tensile modulus [1 mm/min], using ISO 527 parts 1 and 2, of 2900 MPa; a Charpy impact strength, using ISO 179/1eU, of 15 kJ/m²; a notched Charpy impact strength, using ISO 179/1eA, of 1.8 kJ/m²; and a ball indentation hardness, 30-second value, using ISO 2039 part 1, with an applied load of 961 N, of 184 N/mm²; a heat deflection temperature HDT/B (0.45 MPa), using ISO 75 parts 1 and 2, of 130° C.; a coefficient of linear thermal expansion, using ISO 11 359 parts 1 and 2, of 0.6×10⁻⁴ K⁻¹ and a light transmission (2 mm wall thickness), using ISO 13468-2, of 91%.

### Part I

### Example 1.1

Six 9-layer extruded plastic sheets were formed using a 9 layer blown film line, manufactured by Davis Standard. The sheets had the layers indicated in Table 1.1, with thicknesses indicated in Table 1.2, each having dimensions of about 108 inches wide and 500 feet long.

TABLE 1.1
Multilayered structure.

| Layer | Resin | Wt % of Layer | Wt % of Batch |
|---|---|---|---|
| 1 (outside) | DOWLEX ™ 2056G | 100% | 10% |
| 2 | TOPAS ® 8007F-600 | 100% | 20% |
| 3 | TOPAS ® 8007F-600 | 100% | 10% |
| 4 | TOPAS ® 8007F-600 | 100% | 7% |
| 5 | TOPAS ® 8007F-600 | 100% | 6% |
| 6 | TOPAS ® 8007F-600 | 100% | 7% |
| 7 | TOPAS ® 8007F-600 | 100% | 10% |
| 8 | TOPAS ® 8007F-600 | 100% | 20% |
| 9 (outside) | DOWLEX ™ 2056G | 100% | 10% |

### Example 1.2

The six sheets of Example 1.1 were subjected to testing to determine the tensile strength at yield and elongation at yield according to ASTM 882. The slope of the stress strain curve was calculated from test initiation to film yield and that line was offset 1% from the stress strain curve. Results are shown in Table 1.2, comparing the properties to a polyethylene film made on the same blown film line as the multilayered structure of Example 1.1 but only having a single approximately 3 mil layer of DOWLEX™ 2056 G. The test results indicate that film A has much better performance than film B regardless the test temperature with only about one third the thickness.

TABLE 1.2
Physical properties of multilayered structure, where MD indicated
machine direction, and TD indicates transverse to machine direction.

| Film Construction | | B: PE | A: 9-layer |
|---|---|---|---|
| Thickness | Target | 3.0 mil | 1.0 mil |
| (mil) | | | |
| MD | Thickness | 2.83 mil | 1.01 mil |
| (Room temp) | Tensile Stress at Yield | 811.04 psi/5.59 MPa | 3577.11 psi/24.66 MPa |
| | (1% ooffset) | | |
| | Extension @ Yield (1% | 4.13% | 6.43% |
| | Offset) | | |
| TD | Thickness | 2.81 mil | 1.02 mil |
| (Room | Tensile Stress at Yield | 921.89 psi/6.36 MPa | 5127.68 psi/35.35 MPa |
| Temp) | (1% offset) | | |
| | Extension @ Yield (1% | 4.07% | 6.79% |
| | Offset] | | |
| MD (−40° C.) | Thickness | 2.83 mil | 1.01 mil |
| | Tensile Stress at Yield | 2,986.65 psi/20.59 MPa | 6508.37 psi/44.87 MPa |
| | (1% offset) | | |
| | Extension @ Yield (1% | 2.98% | 5.98% |
| | Offset) | | |
| TD (−40° C.) | Thickness | 2.79 mil | 0.98 mil |
| | Tensile Stress at Yield | 3,366.33 psi/23.21 MPa | 6485.77 psi/44.72 MPa |
| | (1% offset) | | |
| | Extension @ Yield (1% | 3.49% | 6.34% |
| | Offset) | | |
| MD (−60° C.) | Thickness | 2.81 mil | 0.99 |
| | Tensile Stress at Yield | 4,072.10 psi/28.08 MPa | 9615.48 psi/66.30 MPa |
| | (1% offset) | | |
| | Extension @ Yield (1% | 2.98% | 6.17% |
| | Offset) | | |
| TD (−60° C.) | Thickness | 2.80 mil | 1 mil |
| | Tensile Stress at Yield | 4,628.07 psi/31.90 MPa | 8936.74 psi/61.62 MPa |
| | (1% offset) | | |
| | Extension @ Yield (1% | 3.51% | 6.68% |
| | Offset) | | |

### Example 1.3

A 9-layer extruded sheet was formed using the technique described in Example 1, having the layers described in Table 1.3, having a thickness of 1 mil.

TABLE 1.3
Multilayered structure.

| Layer | Resin | Wt % of Layer | Wt % of Batch |
|---|---|---|---|
| 1 (outside) | DOWLEX ™ 2056G | 100% | 5% |
| 2 | DOWLEX ™ 2056G | 100% | 22.5% |
| 3 | TOPAS ® 8007F-600 | 100% | 11% |
| 4 | DOWLEX ™ 2056G | 100% | 6% |
| 5 | TOPAS ® 8007F-600 | 100% | 11% |
| 6 | DOWLEX ™ 2056G | 100% | 6% |
| 7 | TOPAS ® 8007F-600 | 100% | 11% |
| 8 | DOWLEX ™ 2056G | 100% | 22.5% |
| 9 (outside) | DOWLEX ™ 2056G | 100% | 5% |

### Example 1.4

A 9-layer extruded sheet was formed using the technique described in Example 1, having the layers described in Table 1.4, having a thickness of 1 mil.

TABLE 1.4
Multilayered structure.

| Layer | Resin | Wt % of Layer | Wt % of Batch |
|---|---|---|---|
| 1 (outside) | MARFLEX ®D350 | 100% | 7% |
| 2 | TOPAS ® 8007F-600 | 100% | 22% |
| 3 | TOPAS ® 8007F-600 | 100% | 10% |
| 4 | MARFLEX ®D350 | 100% | 8% |
| 5 | TOPAS ® 8007F-600 | 100% | 6% |
| 6 | MARFLEX ®D350 | 100% | 8% |
| 7 | TOPAS ® 8007F-600 | 100% | 10% |
| 8 | TOPAS ® 8007F-600 | 100% | 22% |
| 9 (outside) | MARFLEX ®D350 | 100% | 7% |

### Example 1.5

### Hypothetical

A 9-layer extruded sheet was formed using the technique described in Example 1, having the layers described in Table 1.5, having a thickness of 1 mil.

TABLE 1.5
Multilayered structure.

| Layer | Resin | Wt % of Layer | Wt % of Batch |
|---|---|---|---|
| 1 (outside) | DOWLEX ™ 2056G | 100% | 11.1% |
| 2 | TOPAS ® 8007F-600 | 100% | 11.1% |
| 3 | DOWLEX ™ 2056G | 100% | 11.1% |
| 4 | TOPAS ® 8007F-600 | 100% | 11.1% |
| 5 | DOWLEX ™ 2056G | 100% | 11.1% |
| 6 | DOWLEX ™ 2056G | 100% | 11.1% |
| 7 | TOPAS ® 8007F-600 | 100% | 11.1% |
| 8 | DOWLEX ™ 2056G | 100% | 11.1% |
| 9 (outside) | TOPAS ® 8007F-600 | 100% | 11.1% |

### Example 1.6

### Hypothetical

A 9-layer extruded sheet was formed using the technique described in Example 1, having the layers described in Table 1.6, having a thickness of 1 mil.

TABLE 1.6
Multilayered structure.

| Layer | Resin | Wt % of Layer | Wt % of Batch |
|---|---|---|---|
| 1 (outside) | DOWLEX ™ 2056G | 100% | 11.1% |
| 2 | TOPAS ® 8007F-600 | 100% | 11.1% |
| 3 | DOWLEX ™ 2056G | 100% | 11.1% |
| 4 | TOPAS ® 8007F-600 | 100% | 11.1% |
| 5 | TOPAS ® 8007F-600 | 100% | 11.1% |
| 6 | DOWLEX ™ 2056G | 100% | 11.1% |
| 7 | TOPAS ® 8007F-600 | 100% | 11.1% |
| 8 | DOWLEX ™ 2056G | 100% | 11.1% |
| 9 (outside) | TOPAS ® 8007F-600 | 100% | 11.1% |

### Part II

### Example 2.1 (Comparative)

A 9-layer extruded plastic sheet (9 mils thick, 20 inches wide, and 500 ft long) was formed using a 9 layer blown film line, manufactured by Brampton. The sheet had the layers indicated in Table 2.1. Three test bags were fabricated from the extruded plastic, were thermally sealed, and had dimensions of about 20 inches wide and 90 inches long.

The bags were then subjected to a pressure failure test, designed to mimic creep failure conditions, using an Integra bag tester, by inflating the bags to 12 psi overnight (about 8 hours) and then increasing the pressure at a rate 0.001 psi/s. The bags tested at an average wall stress or hoop stress of 1437 psi at failure, with all failures occurring in the parent material (not seal failures). The test required about 12 hours, including about 4 hours of the pressure ramp up.

TABLE 2.1
Nylon core.

| Layer | Resin | Wt % of Layer | Wt % of Batch |
|---|---|---|---|
| 1 (outside) | 62 metallocene | 100% | 7% |
| 2 | 62 metallocene | 100% | 27% |
| 3 | 28 tie | 100% | 6% |
| 4 | Nylon | 100% | 7% |
| 5 | Nylon | 100% | 6% |
| 6 | Nylon | 100% | 7% |
| 7 | 28 tie | 100% | 6% |
| 8 | 62 metallocene | 100% | 27% |
| 9 (outside) | 62 metallocene | 100% | 7% |

### Example 2.2

### COC Core Pressure Test

A 9-layer extruded plastic sheet having the same dimensions as the sheet constructed in Comparative Example 2.1 was formed using the procedure described in Example 1 and having the layers indicated in Table 2.2. Three test bags were fabricated from the extruded plastic layer, having the same dimensions and fabrication method as that described in Example 2.1. The three bags were tested in the same fashion as described in Example 2.1. The average was stress or hoop stress at failure was 1738 psi, with all failures occurring in the parent material (not seal failures), a 21% improvement over Example 2.1.

TABLE 2.2
COC core.

| Layer | Resin | Wt % of Layer | Wt % of Batch |
|---|---|---|---|
| 1 (outside) | 62 metallocene | 100% | 7% |
| 2 | 62 metallocene | 100% | 27% |
| 3 | 82 octene | 100% | 6% |
| 4 | Topas 8007-F400 | 100% | 7% |
| 5 | Topas 8007-F400 | 100% | 6% |
| 6 | Topas 8007-F400 | 100% | 7% |
| 7 | 82 octene | 100% | 6% |
| 8 | 62 metallocene | 100% | 27% |
| 9 (outside) | 62 metallocene | 100% | 7% |

### Example 2.3 (Comparative)

### Nylon Core, Pressure Test with Water and Heating

Three nylon-containing bags were fabricated as described in Example 2.1.

About 2 cups of water was put into the bags, and the bags were floated in a heated water bath at about 130° F. The bags were held at 4 psi overnight (e.g. about 8 hours) and then the pressure was increased at a rate of 0.001 psi/s until failure. The average was stress or hoop stress at failure was 854 psi, with all failures occurring in the parent material (not seal failures).

### Example 2.4

### COC Core, Pressure Test with Water and Heating

Three COC-containing bags were fabricated as described in Example 2.2.

A similar testing procedure was conducted as described in Example 2.3. The average wall stress or hoop stress at failure was 901 psi, with all failures occurring in the parent material (not seal failures), a 6% increase over Example 2.3.

### Example 2.5 (Comparative)

### Nylon Core, Physical Testing

Tensile tests were performed using specimens (1″×8″) of the plastic sheet formed in Example 2.1, using both dry samples and samples that had been soaked in water for about 2-3 days. Tensile tests were performed as per ASTM D882 at 23° C. and 66° C. for each sample. Results are given in Table 2.3, wherein MD indicates “machine direction” and TD indicates “transverse direction.”

TABLE 2.3
Physical properties of the plastic sheet of Comparative Example 2.1.

| | | Example 1 | | Example 1 | | Example 1 | | Example 1 | |
|---|---|---|---|---|---|---|---|---|---|
| Property | Method | dry 23° C. | | wet 23° C. | | dry 66° C. | | wet 66° C. | |
| Elongation (%) | ASTM | MD | 1149.9 | MD | 1410.9 | MD | 1098.5 | MD | 1235.4 |
| stand. dev. | D 882 | | 167.8 | | 103.3 | | 88.8 | | 111.8 |
| | | TD | 1279.2 | TD | 1699.5 | TD | 1222.2 | TD | 1382.0 |
| | | | 103.0 | | 130.5 | | 72.0 | | 49.2 |
| | | AVG | 1214.5 | AVG | 1555.2 | AVG | 1160.3 | AVG | 1308.7 |
| | | | 98.4 | | 83.2 | | 57.2 | | 61.1 |
| Max load (lbf) | ASTM | MD | 37.4 | MD | 43.3 | MD | 29.8 | MD | 32.2 |
| stand. dev | D 882 | | 3.3 | | 3.4 | | 3.6 | | 3.5 |
| | | TD | 39.1 | TD | 45.2 | TD | 28.9 | TD | 32.0 |
| | | | 2.7 | | 3.2 | | 2.1 | | 2.6 |
| | | AVG | 38.3 | AVG | 44.3 | AVG | 29.3 | AVG | 32.1 |
| | | | 2.1 | | 2.3 | | 2.1 | | 2.2 |
| 10% Secant | ASTM | MD | 40557.0 | MD | 53169.0 | MD | 19834.0 | MD | 18248.0 |
| modulus (psi) | D 882 | | 14206.0 | | 5493.0 | | 2868.0 | | 5776.0 |
| stand. dev. | | TD | 40744.0 | TD | 50590.0 | TD | 20574.0 | TD | 20310.0 |
| | | | 7316.0 | | 4948.0 | | 1258.0 | | 2256.0 |
| | | AVG | 40651.0 | AVG | 51879.0 | AVG | 20204.0 | AVG | 19279.0 |
| | | | 7989.0 | | 3697.0 | | 1566.0 | | 3101.0 |

### Example 2.6

### COC Core, Physical Testing

Tensile tests were performed using specimens of the plastic sheet formed in Example 2, using both dry samples and samples that had been soaked in water for about 2-3 days. Tensile tests were performed at 23° C. and 66° C. for each sample, using the same procedure as described in Example 2.5. Results are given in Table 2.4, wherein MD indicates “machine direction” and TD indicates “transverse direction.”

TABLE 2.4
Physical properties of plastic sheet of Example 2.

| | | Example 2 | | Example 2 | | Example 2 | | Example 2 | |
|---|---|---|---|---|---|---|---|---|---|
| Property | Method | dry 23° C. | | wet 23° C. | | dry 66° C. | | wet 66° C. | |
| Elongation (%) | ASTM | MD | 513.2 | MD | 630.7 | MD | 810.7 | MD | 699.9 |
| stand. dev. | D 882 | | 108.6 | | 108.8 | | 71.0 | | 64.6 |
| | | TD | 665.9 | TD | 591.2 | TD | 1666.7 | TD | 1263.5 |
| | | | 128.5 | | 147.6 | | 396.3 | | 414.1 |
| | | AVG | 589.5 | AVG | 610.9 | AVG | 1238.7 | AVG | 981.7 |
| | | | 84.1 | | 91.7 | | 201.3 | | 209.5 |
| Max load (lbf) | ASTM | MD | 25.4 | MD | 29.1 | MD | 20.0 | MD | 20.4 |
| stand. Dev | D 882 | | 2.6 | | 3.7 | | 1.1 | | 1.7 |
| | | TD | 24.9 | TD | 24.6 | TD | 23.3 | TD | 21.9 |
| | | | 2.8 | | 4.1 | | 3.2 | | 3.4 |
| | | AVG | 25.2 | AVG | 26.8 | AVG | 21.7 | AVG | 21.2 |
| | | | 1.9 | | 2.8 | | 1.7 | | 1.9 |
| 10% Secant | ASTM | MD | 83157.0 | MD | 107268.0 | MD | 45608.0 | MD | 57244 |
| Modulus (psi) | D 882 | | 3992.0 | | 7524.0 | | 6938.0 | | 4075 |
| stand. dev. | | TD | 83638.0 | TD | 97832.0 | TD | 37870.0 | TD | 44098 |
| | | | 4602.0 | | 10683.0 | | 10880.0 | | 8091 |
| | | AVG | 83398.0 | AVG | 102550.0 | AVG | 41739.0 | AVG | 50671 |
| | | | 3046.0 | | 6533.0 | | 6452.0 | | 4530 |

The wet specimens of Example 2.1 at both 23° C. and 66° C. showed 5-20% higher tensile properties compared to their dry counterparts, but the samples tested at 66° C. showed lower elongation and max load than those at 23° C. The tensile properties of the specimens of Example 2.2 were about 35-50% lower than the specimens of Example 1 at 23° C. and did not show a significant difference between the wet and dry samples. The max load of the specimens of Example 2.2 decreased by 15-20% at 66° C., but elongation increased by 40-50%, resulting in a similar elongation as the specimens of Example 1 at 66° C.

### Example 2.7

### COC Core Blend

A 9-layer extruded plastic sheet having similar dimensions to the sheet constructed in Example 2.1 was formed using the procedure described in Example 2.1 and having the layers indicated in Table 2.5. Three test bags were fabricated from the extruded plastic layer, having the same dimensions and fabrication method as that described in Example 2.1. The three bags were tested in the same fashion as described in Example 2.3. The average pressure at failure was 15.38 psi, with all failures occurring in the parent material (not seal failures), a 15.3% improvement over Example 2.3.

TABLE 2.5
COC core blend.

| Layer | Resin | Wt % of Layer | Wt % of Batch |
|---|---|---|---|
| 1 (outside) | 62 metallocene | 100% | 7% |
| 2 | 62 metallocene | 100% | 27% |
| 3 | 82 octene | 100% | 6% |
| 4 | Topas 8007-F400 | 50% | 7% |
| | Topas 6013F-04 | 50% | |
| 5 | Topas 8007-F400 | 50% | 6% |
| | Topas 6013F-04 | 50% | |
| 6 | Topas 8007-F400 | 50% | 7% |
| | Topas 6013F-04 | 50% | |
| 7 | 82 octene | 100% | 6% |
| 8 | 62 metallocene | 100% | 27% |
| 9 (outside) | 62 metallocene | 100% | 7% |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a multilayered structure comprising:

at least one A layer (a) comprising a linear olefin polymer or copolymer;

at least one B layer (b) comprising a cyclic olefin polymer or copolymer; and

at least one A layer (c) comprising a linear olefin polymer or copolymer;

wherein the cyclic olefin polymer or copolymer of the at least one B layer is a polymer or copolymer of a substituted or unsubstituted norbornene.

Embodiment 2 provides the multilayered structure of Embodiment 1, wherein the A layers in the multilayered structure alternate with the B layers in the multilayered structure

Embodiment 3 provides the multilayered structure of any one of Embodiments 1-2, wherein each B layer in the multilayered structure has either a B layer or an A layer on each major surface thereof.

Embodiment 4 provides the multilayered structure of any one of Embodiments 1-3, wherein each major surface of each A layer in the multilayered structure has either a B layer thereon, an A layer thereon, or is an external surface on the multilayered structure.

Embodiment 5 provides the multilayered structure of any one of Embodiments 1-4, wherein the multilayered structure comprises an A layer comprising a linear olefin polymer or copolymer on a major external surface.

Embodiment 6 provides the multilayered structure of any one of Embodiments 1-5, wherein the multilayered structure comprises an A layer comprising a linear olefin polymer or copolymer on each major external surface.

Embodiment 7 provides the multilayered structure of any one of Embodiments 1-6, wherein an inner layer of the multilayered structure comprises a lower percentage of linear olefin polymer or copolymer than a layer that is closer to a major external surface of the multilayered structure.

Embodiment 8 provides the multilayered structure of any one of Embodiments 1-7, wherein an inner layer of the multilayered structure comprises a higher percentage of the cyclic olefin copolymer or polymer than a layer that is closer to a major external surface of the multilayered structure.

Embodiment 9 provides the multilayered structure of any one of Embodiments 1-8, wherein the total thickness of the multilayered structure is substantially the same as the total thickness of all of the A layers in the multilayered structure and all of the B layers in the multilayered structure.

Embodiment 10 provides the multilayered structure of any one of Embodiments 1-9, wherein all the A layers in the multilayered structure are about 1 wt % to about 99 wt % of the multilayered structure.

Embodiment 11 provides the multilayered structure of any one of Embodiments 1-10, wherein all the A layers in the multilayered structure are about 30 wt % to about 99 wt % of the multilayered structure.

Embodiment 12 provides the multilayered structure of any one of Embodiments 1-11, wherein the thickness of each A layer is at each occurrence independently about 0.01 mil to about 1 mil.

Embodiment 13 provides the multilayered structure of any one of Embodiments 1-12, wherein the thickness of each A layer is at each occurrence independently about 0.1 mil to about 0.5 mil.

Embodiment 14 provides the multilayered structure of any one of Embodiments 1-13, wherein the concentration of the linear olefin polymer or copolymer in each A layer at each occurrence is independently about 1 wt % to about 100 wt %.

Embodiment 15 provides the multilayered structure of any one of Embodiments 1-14, wherein the concentration of the linear olefin polymer or copolymer in each A layer at each occurrence is independently about 40 wt % to about 100 wt %.

Embodiment 16 provides the multilayered structure of any one of Embodiments 1-15, wherein the linear olefin polymer or copolymer of each A layer is at each occurrence independently chosen from ultra high molecular weight polyethylene (UHMWPE), high-density polyethylene (HDPE), cross-linked polyethylene (PEX or XLPE), medium density polyethylene (MDPE), linear low-density polyethylene (LLDPE), low-density polyethylene (LDPE), very low-density polyethylene (VLDPE), a copolymer thereof, or a combination thereof.

Embodiment 17 provides the multilayered structure of any one of Embodiments 1-16, wherein the linear olefin polymer or copolymer of each A layer is at each occurrence independently chosen from a polymer or copolymer of at least one of propene, butene, pentene, heptene, hexene, octene, nonene, decene, ethylene, a (C₁-C₁₀)alkylenoic acid, a vinyl (C₁-C₁₀)alkanoate ester, and a (C₁-C₁₀)alkyl (C₁-C₁₀)alkylenoate ester.

Embodiment 18 provides the multilayered structure of any one of Embodiments 1-17, wherein the linear olefin polymer or copolymer of each A layer is at each occurrence independently chosen from a linear low-density polyethylene (LLDPE) that comprises a copolymer of ethylene and octene, or a combination thereof.

Embodiment 19 provides the multilayered structure of any one of Embodiments 1-18, wherein in addition to the linear olefin polymer or copolymer, each A layer at each occurrence independently further comprises an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof.

Embodiment 20 provides the multilayered structure of any one of Embodiments 1-19, wherein in addition to the linear olefin polymer or copolymer, each A layer at each occurrence independently further comprises a linear low density polyethylene (LLLDPE), a metallocene-catalyzed PE, an ethylene-vinyl acetate (EVA) polymer, an ethylene-n-butyl acetate polymer (EnBA), or a combination thereof.

Embodiment 21 provides the multilayered structure of any one of Embodiments 1-20, wherein all the B layers in the multilayered structure are about 1 wt % to about 99 wt % of the multilayered structure.

Embodiment 22 provides the multilayered structure of any one of Embodiments 1-21, wherein all the B layers in the multilayered structure are about 30 wt % to about 99 wt % of the multilayered structure.

Embodiment 23 provides the multilayered structure of any one of Embodiments 1-22, wherein the thickness of each B layer is at each occurrence independently about 0.01 mil to about 1 mil.

Embodiment 24 provides the multilayered structure of any one of Embodiments 1-23, wherein the thickness of each B layer is at each occurrence independently about 0.1 mil to about 0.5 mil.

Embodiment 25 provides the multilayered structure of any one of Embodiments 1-24, wherein the concentration of the cyclic olefin polymer or copolymer in each B layer at each occurrence is independently about 1 wt % to about 100 wt %.

Embodiment 26 provides the multilayered structure of any one of Embodiments 1-25, wherein the concentration of the cyclic olefin polymer or copolymer in each B layer at each occurrence is independently about 40 wt % to about 100 wt %.

Embodiment 27 provides the multilayered structure of any one of Embodiments 1-26, wherein the cyclic olefin polymer or copolymer of each B layer is at each occurrence independently a polymer or copolymer of at least one cyclic olefin selected from 8,9,10-trinorborn-2-ene (“norbornene”), 8,9,10-trinorborn-2-ene substituted at at least one of the 5- and 6-position independently with R³, 1,2,3,4,4a,5,8,8a-octahydro-1,4:5,8-dimethanonaphthalene (“tetracyclododecene”), and 1,2,3,4,4a,5,8,8a-octahydro-1,4:5,8-dimethanonaphthalene substituted at at least one of the 2- or 3-position with R³, wherein R³ at each occurrence is independently selected from methyl, ethyl, propyl, butyl, and pentyl, wherein R³ is branched or unbranched.

Embodiment 28 provides the multilayered structure of any one of Embodiments 1-27, wherein the cyclic olefin polymer or copolymer of each B layer at each occurrence independently has the structure:

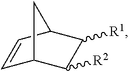

wherein R¹ and R² at each occurrence are each independently selected from H, (C₁-C₁₀)alkyl, (C₂-C₁₀)alkenyl, (C₂-C₁₀)alkynyl, (C₁-C₁₀)haloalkyl, (C₁-C₁₀)alkoxy, (C₁-C₁₀)haloalkoxy, (C₁-C₁₀)cycloalkyl(C₀-C₁₀)alkyl, (C₁-C₁₀)heterocyclyl(C₀-C₁₀)alkyl, (C₁-C₁₀)aryl(C₀-C₁₀)alkyl, and (C₁-C₁₀)heteroaryl(C₀-C₁₀)alkyl, F, Cl, Br, I, OR, CN, CF₃, OCF₃, R, O, S, C(O), S(O), methylenedioxy, ethylenedioxy, N(R)₂, SR, S(O)R, SO₂R, SO₂N(R)₂, SO₃R, C(O)R, C(O)C(O)R, C(O)CH₂C(O)R, C(S)R, C(O)OR, OC(O)R, OC(O)OR, C(O)N(R)₂, OC(O)N(R)₂, C(S)N(R)₂, (CH₂)₀₋₂NHC(O)R, N(R)N(R)C(O)R, N(R)N(R)C(O)OR, N(R)N(R)C(O)N(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(C(O)R)C(O)R, N(OR)R, C(═NH)N(R)₂, C(O)N(OR)R, and C(═NOR)R, or wherein R¹ and R² together form the substituted or unsubstituted structure:

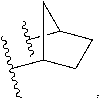 [SMILES: *C1CCC(*)C1]

wherein R at each occurrence is independently substituted or unsubstituted and is selected from the group consisting of hydrogen, (C₁-C₁₀)alkyl, (C₁-C₁₀)cycloalkyl, (C₁-C₁₀)cycloalkyl(C₁-C₁₀)alkyl, (C₁-C₁₀)aryl, (C₁-C₁₀)aralkyl, (C₁-C₁₀)heterocyclyl, (C₁-C₁₀)heterocyclyl(C₁-C₁₀)alkyl, (C₁-C₁₀)heteroaryl, and (C₁-C₁₀)heteroaryl(C₁-C₁₀)alkyl.

Embodiment 29 provides the multilayered structure of any one of Embodiments 1-28, wherein the cyclic olefin polymer or copolymer of each B layer at each occurrence independently has the structure:

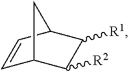

wherein R¹ and R² at each occurrence are each independently selected from H, (C₁-C₁₀)alkyl, (C₁-C₁₀)haloalkyl, (C₁-C₁₀)alkoxy, (C₁-C₁₀)haloalkoxy, F, Cl, Br, I, CN, CF₃, OCF₃, or wherein R¹ and R² together form the structure:

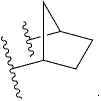 [SMILES: *C1CCC(*)C1]

Embodiment 30 provides the multilayered structure of any one of Embodiments 1-29, wherein the cyclic olefin polymer or copolymer of each B layer at each occurrence independently is a copolymer of a cyclic olefin and at least one of ethylene, propene, butene, pentene, heptene, hexene, octene, nonene, decene, a (C₁-C₁₀)alkylenoic acid, a vinyl (C₁-C₁₀)alkanoate ester, and a (C₁-C₁₀)alkyl (C₁-C₁₀)alkylenoate ester.

Embodiment 31 provides the multilayered structure of any one of Embodiments 1-30, wherein the cyclic olefin polymer or copolymer of each B layer at each occurrence independently is a copolymer of ethylene and at least one cyclic olefin selected from 8,9,10-trinorborn-2-ene (norbornene), 1,2,3,4,4a,5,8,8a-octahydro-1,4:5,8-dimethanonaphthalene (tetracyclododecene).

Embodiment 32 provides the multilayered structure of any one of Embodiments 1-31, wherein in addition to the cyclic olefin polymer or copolymer, each B layer at each occurrence independently further comprises an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof.

Embodiment 33 provides the multilayered structure of any one of Embodiments 1-32, wherein in addition to the cyclic olefin polymer or copolymer, each B layer at each occurrence independently further comprises a linear low density polyethylene (LLLDPE), a metallocene-catalyzed PE, an ethylene-vinyl acetate (EVA) polymer, an ethylene-n-butyl acetate polymer (EnBA), or a combination thereof.

Embodiment 34 provides the multilayered structure of any one of Embodiments 1-33, wherein each A layer is at least partially in contact with one or more B layers.

Embodiment 35 provides the multilayered structure of any one of Embodiments 1-34, wherein each B layer is at least partially in contact with one or more A layers.

Embodiment 36 provides the multilayered structure of any one of Embodiments 1-35, wherein the one or more layers (a) and the one or more layers (c) are external layers of the multilayered structure.

Embodiment 37 provides the multilayered structure of any one of Embodiments 1-36, wherein

the one or more layers (a) are at least partially in contact with the one or more layers (b), and

the one or more layers (b) are at least partially in contact with the one or more layers (c).

Embodiment 38 provides the multilayered structure of any one of Embodiments 1-37, further comprising one or more additional layers comprising an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, an ethylene n-butyl acetate polymer (EnBA), a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof.

Embodiment 39 provides the multilayered structure of any one of Embodiments 1-38, further comprising one or more additional layers comprising a linear low density polyethylene (LLLDPE), a metallocene-catalyzed PE, an ethylene-vinyl acetate (EVA) polymer, an ethylene-n-butyl acetate polymer (EnBA), or a combination thereof.

Embodiment 40 provides the multilayered structure of any one of Embodiments 1-39, wherein each layer independently optionally comprises a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, an antioxidant, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, an antioxidant, a pigment, a polyolefin, a flow control additive, scrim, antistatic additives, antiblock additives, or a combination thereof.

Embodiment 41 provides the multilayered structure of any one of Embodiments 1-40, wherein the multilayered structure has an overall thickness of about 0.1 mil to about 10 mils.

Embodiment 42 provides the multilayered structure of any one of Embodiments 1-41, wherein the multilayered structure has an overall thickness of about 0.5 mil to about 1.5 mils.

Embodiment 43 provides the multilayered structure of any one of Embodiments 1-42, wherein at about room temperature, in the machine direction, the multilayered structure has a tensile strength at yield of about 5 MPa to about 100 MPa per 1 mil total thickness.

Embodiment 44 provides the multilayered structure of any one of Embodiments 1-43, wherein at about room temperature, in the machine direction, the multilayered structure has a tensile strength at yield of about 20 MPa to about 30 MPa per 1 mil total thickness.

Embodiment 45 provides the multilayered structure of any one of Embodiments 1-44, wherein at about room temperature, in the machine direction, the multilayered structure has an elongation at yield of about 2% to about 10%.

Embodiment 46 provides the multilayered structure of any one of Embodiments 1-45, wherein at about room temperature, in the machine direction, the multilayered structure has an elongation at yield of about 6% to about 7%.

Embodiment 47 provides the multilayered structure of any one of Embodiments 1-46, wherein at about −40° C., in the machine direction, the multilayered structure has a tensile strength at yield of about 5 MPa to about 100 MPa per 1 mil total thickness.

Embodiment 48 provides the multilayered structure of any one of Embodiments 1-47, wherein at about −40° C., in the machine direction, the multilayered structure has a tensile strength at yield of about 40 MPa to about 50 MPa per 1 mil total thickness.

Embodiment 49 provides the multilayered structure of any one of Embodiments 1-48, wherein at about −40° C., in the machine direction, the multilayered structure has an elongation at yield of about 2% to about 10%.

Embodiment 50 provides the multilayered structure of any one of Embodiments 1-49, wherein at about −40° C., in the machine direction, the multilayered structure has an elongation at yield of about 5.5% to about 7%.

Embodiment 51 provides the multilayered structure of any one of Embodiments 1-50, wherein at about −60° C., in the machine direction, the multilayered structure has a tensile strength at yield of about 5 MPa to about 100 MPa per 1 mil total thickness.

Embodiment 52 provides the multilayered structure of any one of Embodiments 1-51, wherein at about −60° C., in the machine direction, the multilayered structure has a tensile strength at yield of about 60 MPa to about 75 MPa per 1 mil total thickness.

Embodiment 53 provides the multilayered structure of any one of Embodiments 1-52, wherein at about −60° C., in the machine direction, the multilayered structure has an elongation at yield of about 2% to about 10%.

Embodiment 54 provides the multilayered structure of any one of Embodiments 1-53, wherein at about −60° C., in the machine direction, the multilayered structure has an elongation at yield of about 5.5% to about 7.5%.

Embodiment 55 provides the multilayered structure of any one of Embodiments 1-54, wherein the multilayered structure is substantially recyclable.

Embodiment 56 provides the multilayered structure of any one of Embodiments 1-55, wherein the multilayered structure has an optical transmittance of about 0% to about 100%/

Embodiment 57 provides the multilayered structure of any one of Embodiments 1-56, wherein the multilayered structure has an optical transmittance of about 50% to about 100%.

Embodiment 58 provides the multilayered structure of any one of Embodiments 1-57, wherein the multilayered structure is extruded using at least one of cast sheet extrusion, cast film extrusion, blown sheet extrusion, and blown film extrusion.

Embodiment 59 provides the multilayered structure of any one of Embodiments 1-58, comprising:

the at least one A layer (a) comprising a linear olefin polymer or copolymer;

the at least one B layer (b) comprising:
a B layer (b1) comprising a cyclic olefin polymer or copolymer,
a B layer (b2) comprising a cyclic olefin polymer or copolymer,
a B layer (b3) comprising a cyclic olefin polymer or copolymer,
a B layer (b4) comprising a cyclic olefin polymer or copolymer,
a B layer (b5) comprising a cyclic olefin polymer or copolymer,
a B layer (b6) comprising a cyclic olefin polymer or copolymer, and
a B layer (b7) comprising a cyclic olefin polymer or copolymer; and

the at least one A layer (c) comprising a linear olefin polymer or copolymer.

Embodiment 60 provides the multilayered structure of Embodiment 59, wherein the one or more layers (a) and the one or more layers (c) are external layers of the multilayered structure.

Embodiment 61 provides the multilayered structure of any one of Embodiments 59-60, wherein

the one or more layers (a) are at least partially in contact with the layer (b1),

the layer (b1) is at least partially in contact with the layer (b2),

the layer (b2) is at least partially in contact with the layer (b3),

the layer (b3) is at least partially in contact with the layer (b4),

the layer (b4) is at least partially in contact with the layer (b5),

the layer (b5) is at least partially in contact with the layer (b6),

the layer (b6) is at least partially in contact with the layer (b7), and

the layer (b7) is at least partially in contact with the one or more layers (c).

Embodiment 62 provides the multilayered structure of any one of Embodiments 1-61, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer; and

at least one A layer (e) comprising a linear olefin polymer or copolymer.

Embodiment 63 provides the multilayered structure of Embodiment 62, wherein the one or more layers (a) and the one or more layers (e) are external layers of the multilayered structure.

Embodiment 64 provides the multilayered structure of any one of Embodiments 62-63, wherein

the one or more layers (a) are at least partially in contact with the one or more layers (b),

the one or more layers (b) are at least partially in contact with the one or more layers (c),

the one or more layers (c) are at least partially in contact with the one or more layers (d), and

the one or more layers (d) are at least partially in contact with the one or more layers (e).

Embodiment 65 provides the multilayered structure of any one of Embodiments 1-64, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer; and

at least one A layer (g) comprising a linear olefin polymer or copolymer.

Embodiment 66 provides the multilayered structure of Embodiment 65, wherein the one or more layers (a) and the one or more layers (g) are external layers of the multilayered structure.

Embodiment 67 provides the multilayered structure of any one of Embodiments 65-66, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f), and

the one or more layers (f) are at least partially in contact with the one or more layers (g).

Embodiment 68 provides the multilayered structure of any one of Embodiments 65-67, comprising:

the at least one A layer (a) comprising a linear olefin polymer or copolymer;

the at least one B layer (b) comprising
a B layer (b1) comprising a cyclic olefin polymer or copolymer, and
a B layer (b2) comprising a cyclic olefin polymer or copolymer;

the at least one A layer (c) comprising a linear olefin polymer or copolymer;

the least one B layer (d) comprising a cyclic olefin polymer or copolymer;

the least one A layer (e) comprising a linear olefin polymer or copolymer;

the least one B layer (f) comprising
a B layer (f1) comprising a cyclic olefin polymer or copolymer, and
a B layer (f2) comprising a cyclic olefin polymer or copolymer; and

the least one A layer (g) comprising a linear olefin polymer or copolymer.

Embodiment 69 provides the multilayered structure of Embodiment 68, wherein

the one or more layers (a) are at least partially in contact with the layer (b1),

the layer (b1) is at least partially in contact with the layer (b2),

the layer (b2) is at least partially in contact with the one or more layers (c),

the one or more layers (e) are in contact with the layer (f1),

the layer (f1) is at least partially in contact with the layer (f2), and

the layer (f2) is at least partially in contact with the one or more layers (g).

Embodiment 70 provides the multilayered structure of any one of Embodiments 65-69, comprising:

the at least one A layer (a) comprising
an A layer (a1) comprising a linear olefin polymer or copolymer, and
an A layer (a2) comprising a linear olefin polymer or copolymer;

the at least one B layer (b) comprising a cyclic olefin polymer or copolymer;

the at least one A layer (c) comprising a linear olefin polymer or copolymer;

the at least one B layer (d) comprising a cyclic olefin polymer or copolymer;

the at least one A layer (e) comprising a linear olefin polymer or copolymer;

the at least one B layer (f) comprising a cyclic olefin polymer or copolymer; and

the at least one A layer (g) comprising
an A layer (g1) comprising a linear olefin polymer or copolymer, and
an A layer (g2) comprising a linear olefin polymer or copolymer.

Embodiment 71 provides the multilayered structure of Embodiment 70, wherein

the layer (a1) is at least partially in contact with the layer (a2),

the layer (a2) is at least partially in contact with the one or more layers (b),

the one or more layers (f) are at least partially in contact with the layer (g1), and

the layer (g1) is at least partially in contact with the layer (g2).

Embodiment 72 provides the multilayered structure of any one of Embodiments 1-71, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer;

at least one A layer (g) comprising a linear olefin polymer or copolymer; and

at least one B layer (h) comprising a cyclic olefin polymer or copolymer.

Embodiment 73 provides the multilayered structure of Embodiment 72, wherein the one or more layers (a) and the one or more layers (h) are external layers of the multilayered structure.

Embodiment 74 provides the multilayered structure of any one of Embodiments 72-73, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f),

the one or more layers (f) are at least partially in contact with the one or more layers (g), and

the one or more layers (g) are at least partially in contact with the one or more layers (h).

Embodiment 75 provides the multilayered structure of any one of Embodiments 72-74, comprising

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

the at least one B layer (d) comprising
a B layer (d1) comprising a cyclic olefin polymer or copolymer, and
a B layer (d2) comprising a cyclic olefin polymer or copolymer;

the at least one A layer (e) comprising a linear olefin polymer or copolymer;

the at least one B layer (f) comprising a cyclic olefin polymer or copolymer;

the at least one A layer (g) comprising a linear olefin polymer or copolymer; and

the at least one B layer (h) comprising a cyclic olefin polymer or copolymer.

Embodiment 76 provides the multilayered structure of Embodiment 75, wherein

the one or more layers (c) are at least partially in contact with the layer (d1),

the layer (d1) is at least partially in contact with the layer (d2), and

the layer (d2) is at least partially in contact with the one or more layers (e).

Embodiment 77 provides the multilayered structure of any one of Embodiments 72-76, comprising

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

the at least one B layer (d) comprising a cyclic olefin polymer or copolymer;

the at least one A layer (e) comprising
an A layer (e1) comprising a linear olefin polymer or copolymer, and
an A layer (e2) comprising a linear olefin polymer or copolymer;

the at least one B layer (f) comprising a cyclic olefin polymer or copolymer;

the at least one A layer (g) comprising a linear olefin polymer or copolymer; and

the at least one B layer (h) comprising a cyclic olefin polymer or copolymer.

Embodiment 78 provides the multilayered structure of Embodiment 77, wherein

the one or more layers (d) are at least partially in contact with the layer (e1),

the layer (e1) is at least partially in contact with the layer (e2), and

the layer (e2) is at least partially in contact with the one or more layers (f).

Embodiment 79 provides the multilayered structure of any one of Embodiments 1-78, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer;

at least one A layer (g) comprising a linear olefin polymer or copolymer;

at least one B layer (h) comprising a cyclic olefin polymer or copolymer; and

at least one A layer (i) comprising a linear olefin polymer or copolymer.

Embodiment 80 provides the multilayered structure of Embodiment 79, wherein the one or more layers (a) and the one or more layers (i) are external layers of the multilayered structure.

Embodiment 81 provides the multilayered structure of any one of Embodiments 79-80, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f),

the one or more layers (f) are at least partially in contact with the one or more layers (g),

the one or more layers (g) are at least partially in contact with the one or more layers (h), and

the one or more layers (h) are at least partially in contact with the one or more layers (i).

Embodiment 82 provides the multilayered structure of any one of Embodiments 1-81, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer;

at least one A layer (g) comprising a linear olefin polymer or copolymer;

at least one B layer (h) comprising a cyclic olefin polymer or copolymer;

at least one A layer (i) comprising a linear olefin polymer or copolymer;

at least one B layer (j) comprising a cyclic olefin polymer or copolymer; and

at least one A layer (k) comprising a linear olefin polymer or copolymer.

Embodiment 83 provides the multilayered structure of Embodiment 82, wherein the one or more layers (a) and the one or more layers (k) are external layers of the multilayered structure.

Embodiment 84 provides the multilayered structure of any one of Embodiments 82-83, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f),

the one or more layers (f) are at least partially in contact with the one or more layers (g),

the one or more layers (g) are at least partially in contact with the one or more layers (h),

the one or more layers (h) are at least partially in contact with the one or more layers (i),

the one or more layers (i) are at least partially in contact with the one or more layers (j), and

the one or more layers (j) are at least partially in contact with the one or more layers (k).

Embodiment 85 provides the multilayered structure of any one of Embodiments 1-84, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer;

at least one A layer (g) comprising a linear olefin polymer or copolymer;

at least one B layer (h) comprising a cyclic olefin polymer or copolymer;

at least one A layer (i) comprising a linear olefin polymer or copolymer;

at least one B layer (j) comprising a cyclic olefin polymer or copolymer;

at least one A layer (k) comprising a linear olefin polymer or copolymer;

at least one B layer (l) comprising a cyclic olefin polymer or copolymer; and

at least one A layer (m) comprising a linear olefin polymer or copolymer.

Embodiment 86 provides the multilayered structure of Embodiment 85, wherein the one or more layers (a) and the one or more layers (m) are external layers of the multilayered structure.

Embodiment 87 provides the multilayered structure of any one of Embodiments 85-86, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f),

the one or more layers (f) are at least partially in contact with the one or more layers (g),

the one or more layers (g) are at least partially in contact with the one or more layers (h),

the one or more layers (h) are at least partially in contact with the one or more layers (i),

the one or more layers (i) are at least partially in contact with the one or more layers (j),

the one or more layers (j) are at least partially in contact with the one or more layers (k),

the one or more layers (k) are at least partially in contact with the one or more layers (l), and

the one or more layers (l) are at least partially in contact with the one or more layers (m).

Embodiment 88 provides the multilayered structure of any one of Embodiments 1-87, comprising:

the at least one A layer (a) comprising a linear olefin polymer or copolymer;

the at least one B layer (b) comprising a cyclic olefin polymer or copolymer;

the at least one A layer (c) comprising a linear olefin polymer or copolymer;

at least one B layer (d) comprising a cyclic olefin polymer or copolymer;

at least one A layer (e) comprising a linear olefin polymer or copolymer;

at least one B layer (f) comprising a cyclic olefin polymer or copolymer;

at least one A layer (g) comprising a linear olefin polymer or copolymer;

at least one B layer (h) comprising a cyclic olefin polymer or copolymer;

at least one A layer (i) comprising a linear olefin polymer or copolymer;

at least one B layer (j) comprising a cyclic olefin polymer or copolymer;

at least one A layer (k) comprising a linear olefin polymer or copolymer;

at least one B layer (l) comprising a cyclic olefin polymer or copolymer;

at least one A layer (m) comprising a linear olefin polymer or copolymer;

at least one B layer (n) comprising a cyclic olefin polymer or copolymer; and

at least one A layer (o) comprising a linear olefin polymer or copolymer.

Embodiment 89 provides the multilayered structure of Embodiment 88, wherein the one or more layers (a) and the one or more layers (o) are external layers of the multilayered structure.

Embodiment 90 provides the multilayered structure of any one of Embodiments 88-89, wherein

the one or more layers (a) are at least partially in contact with the one or more layers (b),

the one or more layers (b) are at least partially in contact with the one or more layers (c),

the one or more layers (c) are at least partially in contact with the one or more layers (d),

the one or more layers (d) are at least partially in contact with the one or more layers (e),

the one or more layers (e) are at least partially in contact with the one or more layers (f),

the one or more layers (f) are at least partially in contact with the one or more layers (g),

the one or more layers (g) are at least partially in contact with the one or more layers (h),

the one or more layers (h) are at least partially in contact with the one or more layers (i),

the one or more layers (i) are at least partially in contact with the one or more layers (j),

the one or more layers (j) are at least partially in contact with the one or more layers (k),

the one or more layers (k) are at least partially in contact with the one or more layers (l),

the one or more layers (l) are at least partially in contact with the one or more layers (m),

the one or more layers (m) are at least partially in contact with the one or more layers (n), and

the one or more layers (n) are at least partially in contact with the one or more layers (o).

Embodiment 91 provides a method of making the multilayered structure of any one of Embodiments 1-90, comprising:

extruding the multilayered structure.

Embodiment 92 provides a balloon comprising the multilayered structure of any one of Embodiments 1-90.

Embodiment 93 provides a method of making a balloon, comprising:

making a balloon comprising the multilayered structure of any one of Embodiments 1-90.

Embodiment 94 provides a multilayered structure, comprising:

an A layer (a) comprising a linear olefin polymer or copolymer, wherein about 100 wt % of layer (a) is the linear olefin polymer or copolymer, wherein layer (a) is about 4% to about 30% of the total thickness of the multilayered structure;

a B layer (b) comprising a polymer or copolymer of a substituted or unsubstituted norbornene,

wherein about 100 wt % of layer (b) is the cyclic olefin polymer or copolymer, wherein layer (b) is about 4% to about 30% of the total thickness of the multilayered structure;

an A layer (c) comprising the linear olefin polymer or copolymer, wherein about 100 wt % of layer (c) is the linear olefin polymer or copolymer, wherein layer (c) is about 4% to about 30% of the total thickness of the multilayered structure;

a B layer (d) comprising the cyclic olefin polymer or copolymer, wherein about 100 wt % of layer (d) is the cyclic olefin polymer or copolymer, wherein layer (d) is about 4% to about 30% of the total thickness of the multilayered structure;

an A layer (e) comprising the linear olefin polymer or copolymer, wherein about 100 wt % of layer (e) is the linear olefin polymer or copolymer, wherein layer (e) is about 4% to about 30% of the total thickness of the multilayered structure;

a B layer (f) comprising the cyclic olefin polymer or copolymer, wherein about 100 wt % of layer (f) is the cyclic olefin polymer or copolymer, wherein layer (f) is about 4% to about 30% of the total thickness of the multilayered structure;

an A layer (g) comprising the linear olefin polymer or copolymer, wherein about 100 wt % of layer (g) is the linear olefin polymer or copolymer, wherein layer (g) is about 4% to about 30% of the total thickness of the multilayered structure;

a B layer (h) comprising the cyclic olefin polymer or copolymer, wherein about 100 wt % of layer (h) is the cyclic olefin polymer or copolymer, wherein layer (h) is about 4% to about 30% of the total thickness of the multilayered structure; and

an A layer (i) comprising the linear olefin polymer or copolymer, wherein about 100 wt % of layer (i) is the linear olefin polymer or copolymer, wherein layer (i) is about 4% to about 30% of the total thickness of the multilayered structure,

wherein the layer (a) is fully in contact with the layer (b), the layer (b) is fully in contact with the layer (c), the layer (c) is fully in contact with the layer (d), the layer (d) is fully in contact with the layer (e), the layer (e) is fully in contact with the layer (f), the layer (f) is fully in contact with the layer (g), the layer (g) is fully in contact with the layer (h), and the layer (h) is fully in contact with the layer (i), and

wherein the multilayered structure has an overall thickness of about 0.5 mil to about 1.5 mil.

Embodiment 95 provides a multilayered structure comprising:

at least one A layer (a) comprising a linear olefin polymer or copolymer, wherein about 100 wt % of one or more layers (a) are the linear olefin polymer or copolymer, wherein one or more layers (a) are about 4% to about 30% of the total thickness of the multilayered structure;

at least one B layer (b) comprising a cyclic olefin polymer or copolymer, wherein about 100 wt % of one or more layers (b) is the cyclic olefin polymer or copolymer, wherein one or more layers (b) are about 40% to about 92% of the total thickness of the multilayered structure; and

at least one A layer (c) comprising the linear olefin polymer or copolymer, wherein about 100 wt % of one or more layers (c) is the linear olefin polymer or copolymer, wherein one or more layers (c) are about 4% to about 30% of the total thickness of the multilayered structure;

wherein the cyclic olefin polymer or copolymer of the B layer is a polymer or copolymer of a substituted or unsubstituted norbornene,

wherein the one or more layers (a) are fully in contact with one or more layers (b), the one or more layers (b) are fully in contact with one or more layers (c), and

wherein the multilayered structure has an overall thickness of about 0.5 mil to about 1.5 mil.

Embodiment 96 provides a multilayered structure, comprising:

an A layer (a) comprising a linear olefin polymer or copolymer, wherein about 100 wt % of layer (a) is the linear olefin polymer or copolymer, wherein layer (a) is about 4% to about 30% of the total thickness of the multilayered structure;

a B layer (b) comprising
a B layer (b1) comprising a cyclic olefin polymer or copolymer, wherein about 100 wt % of layer (b1) is the cyclic olefin polymer or copolymer, wherein layer (b1) is about 4% to about 30% of the total thickness of the multilayered structure, and
a B layer (b2) comprising the cyclic olefin polymer or copolymer, wherein about 100 wt % of layer (b2) is the cyclic olefin polymer or copolymer, wherein layer (b2) is about 4% to about 30% of the total thickness of the multilayered structure;

an A layer (c) comprising the linear olefin polymer or copolymer, wherein about 100 wt % of layer (c) is the linear olefin polymer or copolymer, wherein layer (c) is about 4% to about 30% of the total thickness of the multilayered structure;

a B layer (d) comprising the cyclic olefin polymer or copolymer, wherein about 100 wt % of layer is the cyclic olefin polymer of copolymer, wherein one or more layer (d) is about 4% to about 30% of the total thickness of the multilayered structure;

an A layer (e) comprising the linear olefin polymer or copolymer, wherein about 100 wt % of layer (e) is the linear olefin polymer or copolymer, wherein layer (e) is about 4% to about 30% of the total thickness of the multilayered structure;

a B layer (f) comprising
a B layer (f1) comprising the cyclic olefin polymer or copolymer, wherein about 100 wt % of layer (f1) is the cyclic olefin polymer or copolymer, wherein layer (f1) is about 4% to about 30% of the total thickness of the multilayered structure, and
a B layer (f2) comprising the cyclic olefin polymer or copolymer, wherein about 100 wt % of layer (f2) is the cyclic olefin polymer or copolymer, wherein layer (f2) is about 4% to about 30% of the total thickness of the multilayered structure; and

an A layer (g) comprising the linear olefin polymer or copolymer, wherein about 100 wt % of layer (g) is the linear olefin polymer or copolymer, wherein layer (g) is about 4% to about 30% of the total thickness of the multilayered structure;

wherein the cyclic olefin polymer or copolymer of the B layer is a polymer or copolymer of a substituted or unsubstituted norbornene,

wherein the layer (a) is fully in contact with one or more layer (b1), layer (b1) is fully in contact with layer (b2), layer (b2) is fully in contact with layer (c), layer (c) is fully in contact with layer (d), layer (d) is fully in contact with layer (e), layer (e) is fully in contact with layer (f1), and layer (f1) is fully in contact with layer (g), and

wherein the multilayered structure has an overall thickness of about 0.5 mil to about 1.5 mil.

Embodiment 97 provides a multilayered structure, comprising:

an A layer (a) comprising
an A layer (a1) comprising a linear olefin polymer or copolymer, wherein about 100 wt % layers (a1) is the linear olefin polymer or copolymer, wherein layer (a1) is about 4% to about 30% of the total thickness of the multilayered structure, and
an A layer (a2) comprising the linear olefin polymer or copolymer, wherein about 100 wt % layers (a2) is the linear olefin polymer or copolymer, wherein layer (a2) is about 4% to about 30% of the total thickness of the multilayered structure;

a B layer (b) a cyclic olefin polymer or copolymer, wherein about 100 wt % of layer (b) is the cyclic olefin polymer or copolymer, wherein layer (b) is about 4% to about 30% of the total thickness of the multilayered structure, and

an A layer (c) comprising the linear olefin polymer or copolymer, wherein about 100 wt % of layer (c) is the linear olefin polymer or copolymer, wherein layer (c) is about 4% to about 30% of the total thickness of the multilayered structure;

a B layer (d) comprising the cyclic olefin polymer or copolymer, wherein about 100 wt % of layer is the cyclic olefin polymer of copolymer, wherein one or more layer (d) is about 4% to about 30% of the total thickness of the multilayered structure;

an A layer (e) comprising the linear olefin polymer or copolymer, wherein about 100 wt % of layer (e) is the linear olefin polymer or copolymer, wherein layer (e) is about 4% to about 30% of the total thickness of the multilayered structure;

a B layer (f) comprising the cyclic olefin polymer or copolymer, wherein about 100 wt % of layer (f) is the cyclic olefin polymer or copolymer, wherein layer (f1) is about 4% to about 30% of the total thickness of the multilayered structure; and

an A layer (g) comprising
an A layer (g1) comprising the linear olefin polymer or copolymer, wherein about 100 wt % layers (g1) is the linear olefin polymer or copolymer, wherein layer (g1) is about 4% to about 30% of the total thickness of the multilayered structure, and
an A layer (g2) comprising the linear olefin polymer or copolymer, wherein about 100 wt % layers (g2) is the linear olefin polymer or copolymer, wherein layer (g2) is about 4% to about 30% of the total thickness of the multilayered structure;

wherein the cyclic olefin polymer or copolymer of the B layer is a polymer or copolymer of a substituted or unsubstituted norbornene,

wherein the layer (a1) is fully in contact with layer (a2), layer (a2) is fully in contact with layer (b), layer (b) is fully in contact with layer (c), layer (c) is fully in contact with layer (d), layer (d) is fully in contact with layer (e), layer (e) is fully in contact with layer (f), layer (f) is fully in contact with layer (g1), and layer (g1) is fully in contact with layer (g2), and wherein the multilayered structure has an overall thickness of about 0.5 mil to about 1.5 mil.

Embodiment 98 provides a method of making a multilayered structure comprising:

extruding a multilayered structure comprising
at least one A layer (a) comprising a linear olefin polymer or copolymer;
at least one B layer (b) comprising a cyclic olefin polymer or copolymer; and
at least one A layer (c) comprising a linear olefin polymer or copolymer;
wherein the cyclic olefin polymer or copolymer of the at least one B layer is a polymer or copolymer of a substituted or unsubstituted norbornene.

Embodiment 99 provides the multilayered structure, method, or balloon of apparatus, method, composition, or system of any one or any combination of Embodiments 1-98 optionally configured such that all elements or options recited are available to use or select from.

What is claimed is:

1. A multilayered structure comprising:
at least one A layer (a) comprising a linear olefin polymer or copolymer;
at least one B layer (b) comprising a cyclic olefin polymer or copolymer; and
at least one A layer (c) comprising a linear olefin polymer or copolymer;
wherein the cyclic olefin polymer or copolymer of the at least one B layer is a polymer or copolymer of a substituted or unsubstituted norbornene.

2. The multilayered structure of claim 1, wherein the A layers in the multilayered structure alternate with the B layers in the multilayered structure

3. The multilayered structure of claim 1, wherein the multilayered structure comprises an A layer comprising a linear olefin polymer or copolymer on one or both major external surfaces.

4. The multilayered structure of claim 1, wherein the total thickness of the multilayered structure is substantially the same as the total thickness of all of the A layers in the multilayered structure and all of the B layers in the multilayered structure.

5. The multilayered structure of claim 1, wherein all the A layers in the multilayered structure are about 1 wt % to about 99 wt % of the multilayered structure.

6. The multilayered structure of claim 1, wherein the thickness of each A layer is at each occurrence independently about 0.01 mil to about 1 mil.

7. The multilayered structure of claim 1, wherein the concentration of the linear olefin polymer or copolymer in each A layer at each occurrence is independently about 1 wt % to about 100 wt %.

8. The multilayered structure of claim 1, wherein the linear olefin polymer or copolymer of each A layer is at each occurrence independently chosen from ultra high molecular weight polyethylene (UHMWPE), high-density polyethylene (HDPE), cross-linked polyethylene (PEX or XLPE), medium density polyethylene (MDPE), linear low-density polyethylene (LLDPE), low-density polyethylene (LDPE), very low-density polyethylene (VLDPE), a copolymer thereof, or a combination thereof.

9. The multilayered structure of claim 1, wherein all the B layers in the multilayered structure are about 1 wt % to about 99 wt % of the multilayered structure.

10. The multilayered structure of claim 1, wherein the thickness of each B layer is at each occurrence independently about 0.01 mil to about 1 mil.

11. The multilayered structure of claim 1, wherein the concentration of the cyclic olefin polymer or copolymer in each B layer at each occurrence is independently about 1 wt % to about 100 wt %.

12. The multilayered structure of claim 1, wherein the cyclic olefin polymer or copolymer of each B layer at each occurrence independently has the structure: 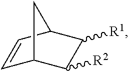
wherein R¹ and R² at each occurrence are each independently selected from H, (C₁-C₁₀)alkyl, (C₂-C₁₀)alkenyl, (C₂-C₁₀)alkynyl, (C₁-C₁₀)haloalkyl, (C₁-C₁₀)alkoxy, (C₁-C₁₀)haloalkoxy, (C₁-C₁₀)cycloalkyl(C₀-C₁₀)alkyl, (C₁-C₁₀)heterocyclyl(C₀-C₁₀)alkyl, (C₁-C₁₀)aryl(C₀-C₁₀)alkyl, and (C₁-C₁₀)heteroaryl(C₀-C₁₀)alkyl, F, Cl, Br, I, OR, CN, CF₃, OCF₃, R, O, S, C(O), S(O), methylenedioxy, ethylenedioxy, N(R)₂, SR, S(O)R, SO₂R, SO₂N(R)₂, SO₃R, C(O)R, C(O)C(O)R, C(O)CH₂C(O)R, C(S)R, C(O)OR, OC(O)R, OC(O)OR, C(O)N(R)₂, OC(O)N(R)₂, C(S)N(R)₂, (CH₂)₀₋₂NHC(O)R, N(R)N(R)C(O)R, N(R)N(R)C(O)OR, N(R)N(R)C(O)N(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(C(O)R)C(O)R, N(OR)R, C(═NH)N(R)₂, C(O)N(OR)R, and C(═NOR)R, or wherein R¹ and R² together form the substituted or unsubstituted structure: 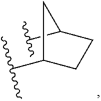 [SMILES: *C1CCC(*)C1]
wherein R at each occurrence is independently substituted or unsubstituted and is selected from the group consisting of hydrogen, (C₁-C₁₀)alkyl, (C₁-C₁₀)cycloalkyl, (C₁-C₁₀)cycloalkyl(C₁-C₁₀)alkyl, (C₁-C₁₀)aryl, (C₁-C₁₀)aralkyl, (C₁-C₁₀)heterocyclyl, (C₁-C₁₀)heterocyclyl(C₁-C₁₀)alkyl, (C₁-C₁₀)heteroaryl, and (C₁-C₁₀)heteroaryl(C₁-C₁₀)alkyl.

13. The multilayered structure of claim 1, wherein
the one or more layers (a) are at least partially in contact with the one or more layers (b), and
the one or more layers (b) are at least partially in contact with the one or more layers (c).

14. The multilayered structure of claim 1, wherein the multilayered structure is substantially recyclable.

15. The multilayered structure of claim 1, comprising:
the at least one A layer (a) comprising a linear olefin polymer or copolymer;
the at least one B layer (b) comprising:
a B layer (b1) comprising a cyclic olefin polymer or copolymer,
a B layer (b2) comprising a cyclic olefin polymer or copolymer,
a B layer (b3) comprising a cyclic olefin polymer or copolymer,
a B layer (b4) comprising a cyclic olefin polymer or copolymer,
a B layer (b5) comprising a cyclic olefin polymer or copolymer,
a B layer (b6) comprising a cyclic olefin polymer or copolymer, and
a B layer (b7) comprising a cyclic olefin polymer or copolymer; and
the at least one A layer (c) comprising a linear olefin polymer or copolymer.

16. The multilayered structure of claim 1, comprising:
the at least one A layer (a) comprising a linear olefin polymer or copolymer;
the at least one B layer (b) comprising a cyclic olefin polymer or copolymer;
the at least one A layer (c) comprising a linear olefin polymer or copolymer;
at least one B layer (d) comprising a cyclic olefin polymer or copolymer;
at least one A layer (e) comprising a linear olefin polymer or copolymer;
at least one B layer (f) comprising a cyclic olefin polymer or copolymer; and
at least one A layer (g) comprising a linear olefin polymer or copolymer.

17. The multilayered structure of claim 16, comprising:
the at least one A layer (a) comprising a linear olefin polymer or copolymer;
the at least one B layer (b) comprising
a B layer (b1) comprising a cyclic olefin polymer or copolymer, and
a B layer (b2) comprising a cyclic olefin polymer or copolymer;
the at least one A layer (c) comprising a linear olefin polymer or copolymer;
the least one B layer (d) comprising a cyclic olefin polymer or copolymer;
the least one A layer (e) comprising a linear olefin polymer or copolymer;
the least one B layer (f) comprising
a B layer (f1) comprising a cyclic olefin polymer or copolymer, and
a B layer (f2) comprising a cyclic olefin polymer or copolymer; and
the least one A layer (g) comprising a linear olefin polymer or copolymer.

18. The multilayered structure of claim 16, comprising:
the at least one A layer (a) comprising
an A layer (a1) comprising a linear olefin polymer or copolymer, and
an A layer (a2) comprising a linear olefin polymer or copolymer;
the at least one B layer (b) comprising a cyclic olefin polymer or copolymer;
the at least one A layer (c) comprising a linear olefin polymer or copolymer;
the at least one B layer (d) comprising a cyclic olefin polymer or copolymer;
the at least one A layer (e) comprising a linear olefin polymer or copolymer;
the at least one B layer (f) comprising a cyclic olefin polymer or copolymer; and
the at least one A layer (g) comprising
an A layer (g1) comprising a linear olefin polymer or copolymer, and
an A layer (g2) comprising a linear olefin polymer or copolymer.

19. The multilayered structure of claim 1, comprising:
the at least one A layer (a) comprising a linear olefin polymer or copolymer;
the at least one B layer (b) comprising a cyclic olefin polymer or copolymer;
the at least one A layer (c) comprising a linear olefin polymer or copolymer;
at least one B layer (d) comprising a cyclic olefin polymer or copolymer;
at least one A layer (e) comprising a linear olefin polymer or copolymer;
at least one B layer (f) comprising a cyclic olefin polymer or copolymer;
at least one A layer (g) comprising a linear olefin polymer or copolymer;
at least one B layer (h) comprising a cyclic olefin polymer or copolymer; and
at least one A layer (i) comprising a linear olefin polymer or copolymer.

20. A balloon comprising the multilayered structure of claim 1.
